(19) United States
(12) Patent Application Publication
(10) Pub. No.: US 2018/0158159 A1
(43) Pub. Date: Jun. 7, 2018

(54) SYSTEMS AND METHODS FOR IMPROVED INNOVATION INSIGHTS AND CAPTURE

(71) Applicant: General Electric Company, Schenectady, NY (US)

(72) Inventors: Lucas Divine, Wauwatosa, WI (US); Ronald Blaski, Wauwatosa, WI (US)

(21) Appl. No.: 15/370,504

(22) Filed: Dec. 6, 2016

(51) Int. Cl. G06Q 50/18; G06Q 30/02

(52) U.S. Cl. CPC G06Q 50/184; G06Q 30/02

(57) ABSTRACT

Systems and techniques for identifying and capturing innovation, including applying analysis to collected innovation information for providing innovation insights are presented. A system can provide technological ways to identify innovation as it is developed, and capture the innovation in data stores. The system can also provide automated means of proposing innovation for intellectual property protection. Further, the system can provide technological ways of identifying innovation insights to help businesses, governments, and other entities take smart actions as a result of innovation capture.

### BACKGROUND

The subject matter disclosed herein relates generally to technologies for identifying and capturing innovation, including applying analysis to collected innovation information for providing innovation insights.

Innovation is a key goal for governments, economies, companies, and individuals. Innovation includes bringing new and interesting ideas to practical ends. Companies seek to make products that customers will buy over the old products and over competitor products. Government seeks to make processes easier and better on practical levels. And individuals improve their lives through innovation and creativity in their homes, workplaces, and recreation. Better products, services, processes, and lives are the great results of innovation.

Generating, identifying, capturing, and protecting innovation are all vital areas that need improvement. Herein proposed are novel technological ways to identify innovation as it is developed, capture the innovation in novel ways, and provide novel automated means of proposing innovation for intellectual property protection. Further, herein proposed are new technological ways of identifying innovation insights to help businesses, governments, and other entities take useful actions as a result of innovation capture.

### BRIEF DESCRIPTION

In accordance with an embodiment, innovation systems and methods are provided that may include a plurality of data storage systems that store general data; an innovation collection engine that receives general data from the plurality of data storage systems, identifies innovation data from within the general data, and stores the innovation data in one or more innovation data stores; and an innovation insights engine that analyzes the stored innovation data, retrieves information data relating to a particular innovation idea, and populates an innovation disclosure form based on the information data related to the particular innovation idea. Further the stored innovation data may include data source information referring to which of the plurality of data storage systems the innovation data originated from; an innovation disclosure form may include a field indicating the data source information for each information datum; and the innovation insights engine populates data source information into the related field in the populated innovation disclosure form.

Identifying innovation may include comparing the general data to innovation criteria, wherein innovation criteria include one or more of: a prior art comparison criterion, a direct input criterion, a keyword criterion, an ideation system feedback criterion, an effort criterion, a funding amount criterion, and a felt need criterion. Further, identifying innovation may further include applying a weighting function to the output of each comparison of the general data to innovation criteria; and identifying the general data as innovation data if the combined weighted outputs from each comparison exceed an innovation threshold.

The innovation insight engine may include a patentability decision engine that receives innovation data and outputs one or more patentability ratings for the innovation data, wherein the patentability decision engine includes a deep learning neural network system; and the patent ability ratings comprise one or more of detectability, likelihood of infringement, idea type, economic impact, breadth of idea, difficulty to design around, novelty, and value to organization.

Further, the innovation insight engine may include an intellectual property decision engine that receives innovation data and outputs one or more intellectual property recommendations for the innovation data. And the intellectual property recommendations may include one or more of file utility patent application, file design patent application, file plant patent application, file utility model patent application, defensive publish, protect trade secret, file copyright, consolidate with another idea, improve idea description, or no further consideration.

In accordance with an embodiment, innovation systems and methods are provided that may include a plurality of data sources that generate and store general data; a communication framework; an innovation collection engine comprising an innovation identification module and an innovation assignment module; a plurality of innovation data stores; wherein: each data source transmits general data through the communication framework to the innovation collection engine; the innovation identification module determines whether the general data is potential innovation; and if the general data is potential innovation, the innovation assignment module assigns it to one or more innovation data stores.

Further, the innovation identification module may perform innovation analysis the general data for one or more of evidence of strength over prior art, direct input of innovation, innovation related keywords, high ratings from an ideation system, amount of effort or funding related to the general data, and long felt need. The innovation identification module may apply a weighting criteria to each of the innovation analyzes; and outputs a recommendation of potential innovation of the general data based on the innovation analyses and respective weighting applied. The innovation identification module may generate and display a user interface window asking for innovation feedback; and the innovation identification module accepts the user feedback and provides the feedback as the direct input of innovation in the innovation analysis; wherein the innovation identification module applies a higher weighting criteria to the direct input of innovation if the user providing the feedback has either the word chief or senior in their job title and a lower weighting criteria to the direct input of innovation if the user providing the feedback does not have either the word chief or senior in their job title.

In accordance with an embodiment, innovation systems and methods are provided that may include analyzing innovation data stored in one or more innovation data stores for trigger criteria; detecting a trigger event based on the one or more trigger criteria; generating an innovation insight related to the trigger criteria and based on the innovation data; and providing the innovation insight to a user. The trigger criteria may be one or more of a public disclosure; keywords across data stores; a project milestone, a budget update; an internal cycle; an intellectual property committee decision or request; a competitive update; a patent filing; a patent grant; a government requirement or deadline; a lawsuit threat or lawsuit claim filing; or customer requirements. The innovation insight may be a pre-populated innovation disclosure form that includes a field indicating the data source information for each innovation datum. The innovation insight may be a confidentiality warning based on confidentiality markings found in the analyzed innovation data. And the systems and methods may also include receiving user feedback based on the provided innovation insight; and providing the user feedback to an innovation collection engine.

### BRIEF DESCRIPTION OF THE DRAWINGS

FIG. 1 illustrates an exemplary teleconference embodiment.

FIG. 2 illustrates an exemplary engineering embodiment.

FIG. 3 illustrates a flowchart of system operation, according to an embodiment.

FIG. 4 illustrates flow of information within an innovation system, according to an embodiment.

FIG. 5 illustrates an innovation collection system, according to an embodiment.

FIG. 6 illustrates a system and method of determining potential innovation, according to an embodiment.

FIG. 7 illustrates a user interface screen for user innovation input, according to an embodiment.

FIG. 8 illustrates an innovation idea to review user interface screen, according to an embodiment.

FIG. 9 illustrates a flowchart of steps taken by the innovation insights engine, according to one or more embodiments.

FIG. 10 illustrates an innovation insight trigger flowchart, according to an embodiment.

FIG. 11 illustrates an innovation idea presented as a disclosure idea for review, according to an embodiment.

FIG. 12 illustrates a process for creating a pre-populated innovation disclosure, according to an embodiment.

FIG. 13 illustrates an exemplary neural network for innovation decision making, according to an embodiment.

FIG. 14 illustrates a pre-populated innovation disclosure, according to an embodiment.

FIG. 15 illustrates a user interface screen for display of innovation ideas to an inventor, according to an embodiment.

FIG. 16 illustrates the process steps for taking innovation actions, according to an embodiment.

FIG. 17 illustrates flowchart generation from software source code, according to an embodiment.

FIG. 18 illustrates a process of innovation brainstorm support, according to an embodiment.

FIG. 19 illustrates a user interface notification, according to an embodiment.

FIG. 20 illustrates an innovation update user interface screen generated by the innovation insights engine, according to an embodiment.

FIG. 21 illustrates an innovation connection suggestion user interface, according to an embodiment.

FIG. 22 illustrates a process of identifying related inventors, according to an embodiment.

FIG. 23 illustrates an innovator connection suggestion user interface, according to an embodiment.

FIG. 24 illustrates prior art search interaction user interfaces, according to an embodiment.

FIG. 25 illustrates additional prior art search interaction user interfaces, according to an embodiment.

FIG. 26 illustrates a user interface of a prior art word cloud, according to an embodiment.

FIG. 27 illustrates a user interface notification related to white space, according to an embodiment.

FIG. 28 illustrates a user interface notification related to innovation ideas that are located in a white space, according to an embodiment.

FIG. 29 illustrates a process for patent portfolio building, according to an embodiment.

FIG. 30 illustrates an innovation insight related to an external activity alert notification, according to an embodiment.

FIG. 31 illustrates an exemplary innovation insight related to patent pool licensing, according to an embodiment.

FIG. 32 illustrates an exemplary innovation insight giving usage feedback to the users, according to an embodiment.

FIG. 33 illustrates an innovation insight related to industry standards, according to an embodiment.

FIG. 34 illustrates a trade secret request user notification, according to an embodiment.

FIG. 35 illustrates an innovation portfolio building process, according to an embodiment.

FIG. 36 illustrates an innovation insight related to trade secret protection, according to an embodiment.

FIG. 37 illustrates an example innovation insight related to protecting innovation before a legal bar date, according to an embodiment.

FIG. 38 is a schematic block diagram illustrating an operating environment, according to an embodiment.

FIG. 39 is a schematic block diagram of a computer environment, according to an embodiment.

### DETAILED DESCRIPTION

The foregoing summary, as well as the following detailed description of certain embodiments and claims, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors, controllers or memories) may be implemented in a single piece of hardware (e.g., a general-purpose signal processor or random access memory, hard disk, or the like) or multiple pieces of hardware. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

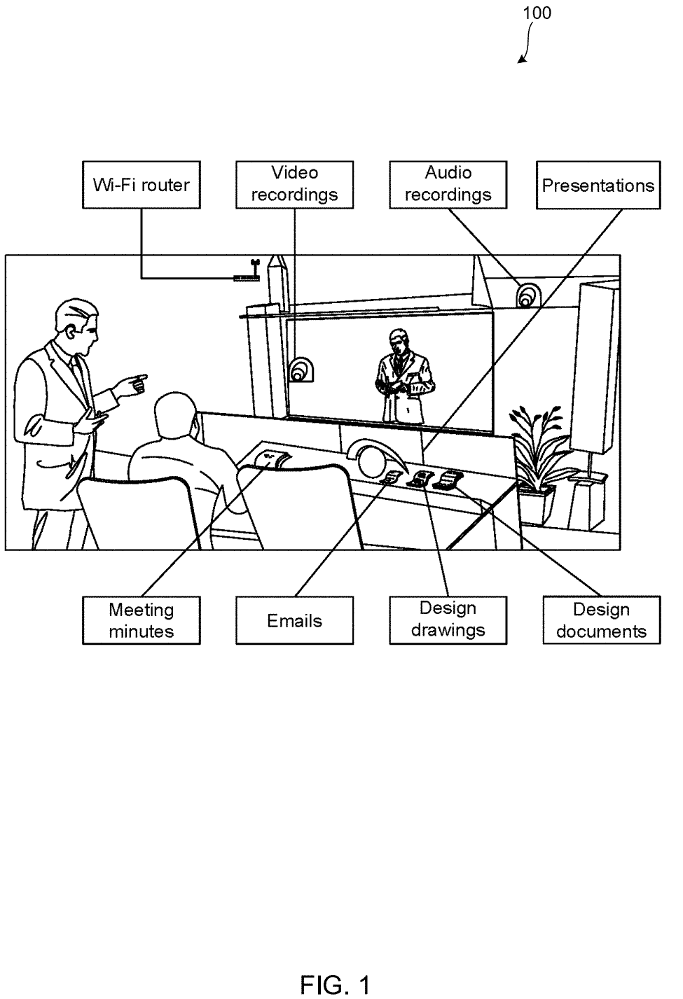

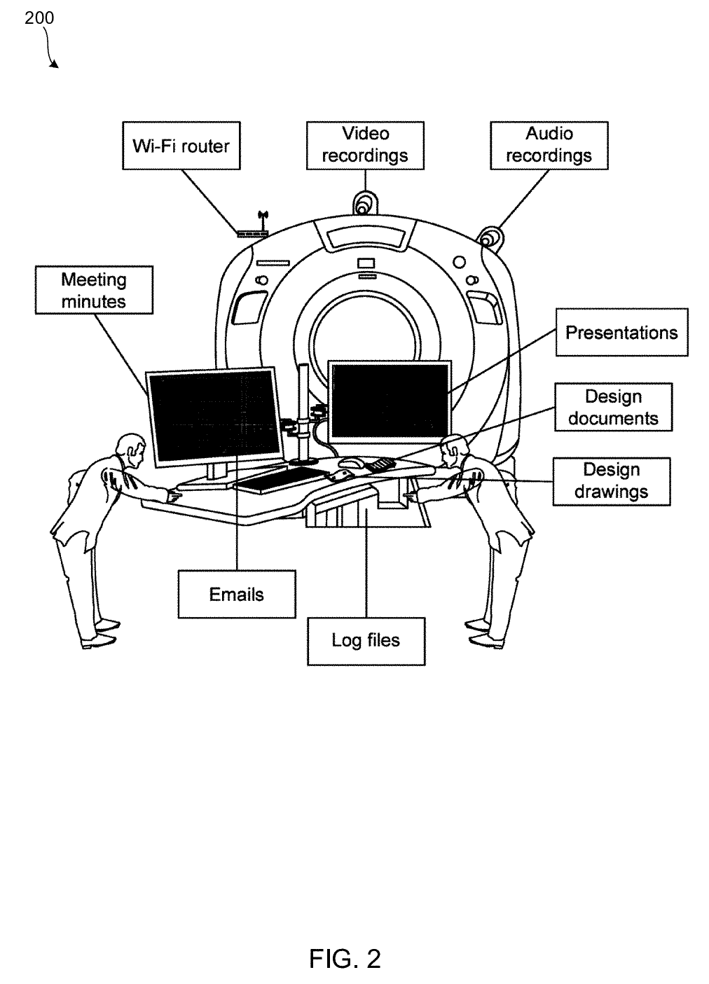

FIG. 1 and FIG. 2 show innovation occurring. They are exemplary embodiments of innovation in our society. Many more innovation environments are contemplated throughout.

FIG. 1 shows a conference room where two people are having a project meeting with a third, remote, person via telepresence or video presence. FIG. 2 shows a mechanical engineering room, or bay or garage, where two people are tinkering and engineering with new designs for a mechanical product.

In both cases, there are many digital data sources to scour for innovation information. FIG. 1 includes sources such as all the internet traffic coming in through the Wi-Fi router; the notes, meeting minutes, design documents, drawings, emails, presentations, and other digital files on the person's computer device; the digital content scanned from the digital white board on the wall; video and audio recordings from the computer device, the audioconference system, and the wall mounted videoconference system; and still images taken from any camera systems. FIG. 2 includes similar inputs as FIG. 1, but also includes log files and a lot more spoken words between the two people who are actively working on the mechanical device. There are many digital sources for collecting, formatting, and using to identify innovation for capture, protection, and insights.

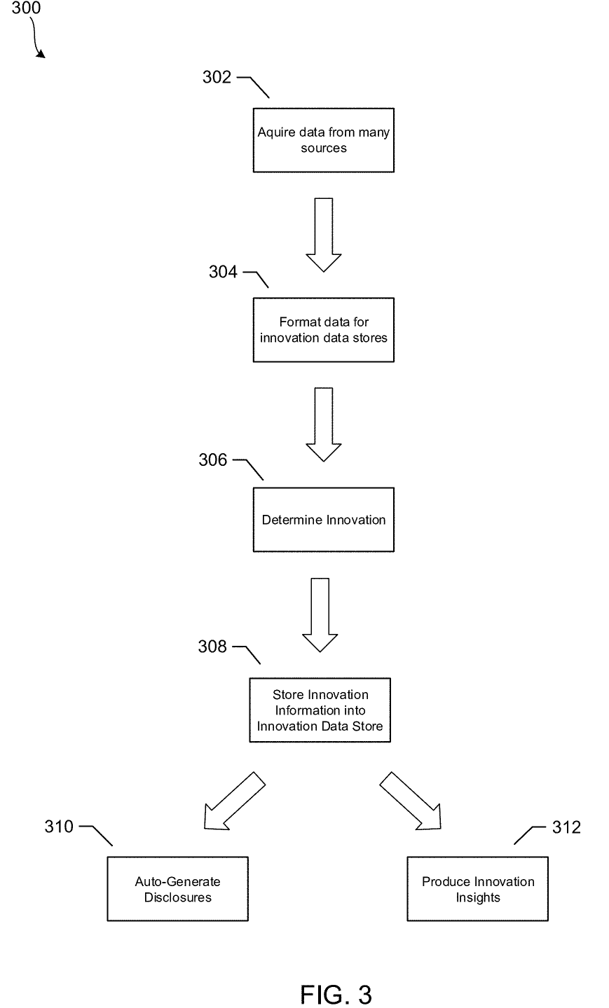

FIG. 3 shows embodiment 300. In step 302, data is acquired from a plethora of digital data sources, such as described related to FIG. 1 and FIG. 2. In step 304, the data is then formatted to be conducive for big data and data lake analysis, as well as the innovation data stores. In step 306, innovation is determined from within the data. In step 308, innovation information is stored in one or more innovation data stores. In step 310 innovation is pulled from the innovation data stores and used to populate innovation disclosures for review for potential intellectual property protection. If legal intellectual property protection is chosen by the entity, the system could format the material as best as possible for the specific type of information and formatting needed for such intellectual property submission in the chosen jurisdiction. Innovation can also be pulled from the innovation data stores to provide innovation insights, as shown in step 312, that help individuals in the organization make improved decisions. Each step will be discussed further herein below.

Through such a system more innovation is identified, captured, and protected than otherwise, and more strategic decisions can be made. Further, innovators can focus more on innovation itself as opposed to spending too much time on identification and documentation. The system can passively monitor, analyze the data, and proposed potential innovation ideas and innovation areas without much, or any, human involvement. These innovation areas can be specific areas where that entity has innovated and could use protection for the innovation. Additionally, the innovation areas proposed could be areas where the entity has room to do more innovation, i.e. white space, such as areas requested by customers or areas were competitors are not moving into yet. Such technology-driven innovation, identification, and documentation saves entities time and money; thus, increasing productivity in the entity.

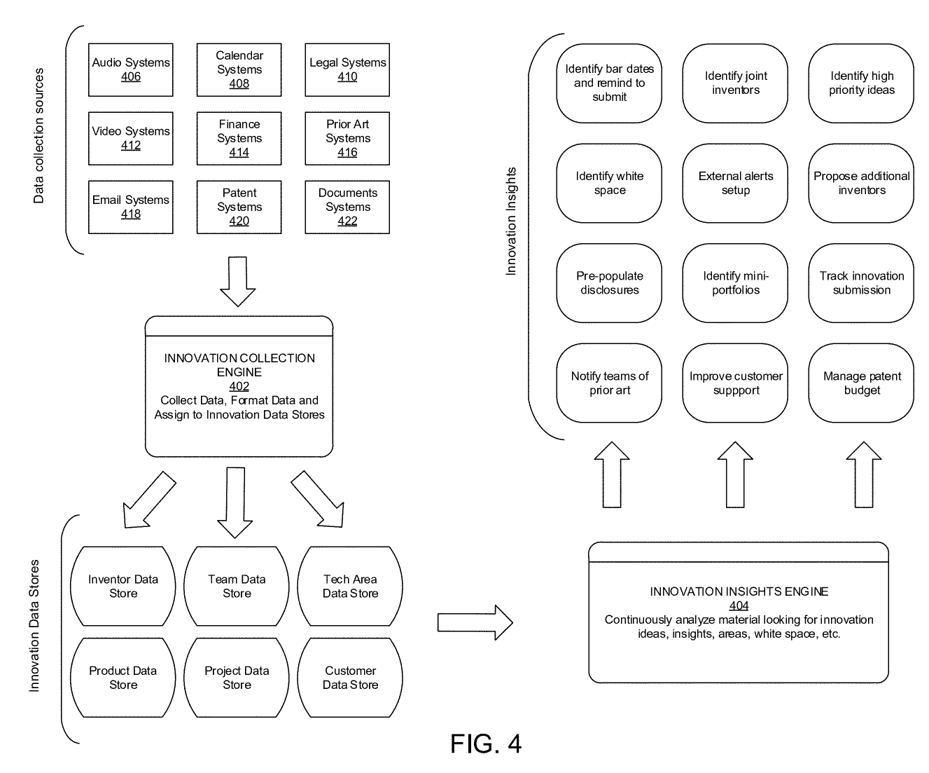

FIG. 4 shows a more detailed overview of an embodiment. The digital system includes two main decision engines. The first decision engine is the innovation collection engine 402. The second decision engine is the innovation insights engine 404.

Innovation collection engine 402 pulls in data from a myriad of sources, such as audio systems 406, calendar systems 408, legal systems 410, video systems 412, finance systems 414, prior art systems 416, email systems 418, patent systems 420, document management systems 422, and other sources as more specifically enumerated below. Innovation collection engine 402 then formats the data into common data formats for analysis by the technological system. Innovation collection engine 402 makes a decision, discussed below, whether a piece of information is worth capturing in an innovation data store or not. It can make this decision through deep learning neural networks that include specific keywords, neural node weighting, and historical information. The innovation collection engine then decides which of the innovation data stores the innovation information should be assigned to. This can also include creating whole new innovation data stores.

FIG. 4 shows examples of innovation data stores that are storing innovation information. Innovation data stores can be specific to an individual, to a team of individuals, a technology area, a project, a product, and/or a customer, according to various embodiments. The term data store here can also be thought of as a data structure or database depending on the specific storage mechanisms chosen for technological implementation by an organization.

Here are some specific examples to help illustrate how innovation data stores may be implemented. One innovation data store may include all the innovation ideas that have been proposed by an inventor, such as Rhonda Smith. The innovation data store may store captured audio transcripts of her proposals from meetings, her emails, her meeting minutes, and the documents on her computer that she is using to design new systems and methods for her employer. A team data store may store the collected innovation ideas from Ken Hu's power engineering team. This data store may include even conversations that were had around cubicles in casual conversation. These can be recorded by the many microphones in security cameras with microphones, telephones, smartphones, computers, and other audio devices around the organization.

Further, the manager may log in and directly add and curate innovation information in the innovation data store. One innovation data store may include the collected information from any teams and groups as long as the topic of the innovation was related to a specific technology area, such as user interfaces. This may include many sketches saved, along with innovation ideas proposed on digital white boards and shared between colleagues through a cloud service. One innovation data store may include innovation information related to a specific project, making it easy for managers to track the various improvements overall to a project. Documents with the project name and meeting notices with the project name are helpful to the innovation collection engine when routing such information to the appropriate innovation data store related to such a project. One innovation data store may include innovation information related to a product on the market. Customers, sales staff, management, engineers all might have continuing feedback on how to improve and innovate on a released product. The system can pull in public tweets, emails, feedback databases, sales team emails, management discussions and product planning meeting notes all could be included in such an innovation database. The system can identify such feedback as related to a certain product or service based on the keywords of the product or service name or nickname.

FIG. 4 also shows the innovation insights engine 404. Once innovation has been identified and assigned into specific innovation data stores it can be mined and analyzed by an innovation insights engine for benefits to the organization. These benefits can be referred to as innovation insights. One output of the systems and methods herein is the insight of an innovation idea for disclosure to be reviewed by an intellectual property committee for potential legal intellectual property protection. Additional innovation insights can be, but are not limited to, identifying competitive technologies and prior art, identifying white space for innovation, identifying legal dates and deadlines to be met, identifying joint inventors and additional groups working on similar ideas in an organization, setting up alerts related to specific individuals or market activity, identifying specific portfolios of innovation across the organization, improving customer support and responsiveness, identifying high priority areas for innovation protection, helping to track innovation submission and non-submission, more effectively manage intellectual property budgets, identify standards opportunities, identify monetization and licensing opportunities, identify business collaboration opportunities, and help innovation brainstorms. Examples of the processes involved to identify and report such insights are discussed herein.

COLLECTION AND FORMATTING OF DATA

Data can be input in the system actively or passively. In an active situation, a user puts information into the system directly and may even indicate which innovation data store the information should go into. For example, inventor A starts to draft an invention disclosure but wants some help. Inventor A can dump any emails, presentations, and other files into the system directly and ask the system to create a disclosure from the data or provide related insights. The system can use the innovation collection engine and the innovation insights engine to find related items specific to the information just put in by inventor A. Further, the system could prompt at certain times to ask questions to make it easier for inventor A. Such prompts could be done through innovation software installed on the user's machine or through communications tools already installed, such as email, web browser, social media, or instant message tools.

Another example of active input of data to the system is a specific short term brainstorm, hackathon, or topical workout session. The leader of the session could specifically instruct the system to focus on certain areas and time windows for collection. For example, the leader instructs the system to focus on emails during a certain time window, meeting information (e.g. voice, video, whiteboard, meeting notes), and calendar system information. The leader could instruct the system through a user interface that allows for specific selection of the input systems and time window. Then passive monitoring and innovation collection would occur, but targeted by the active user engagement.

In a passive situation, which may be a majority of the usage, the system collects all data and monitors for innovation identification. For example, in a meeting situation, the system can detect from the entity's calendar database what the title and meeting notes are for the meeting, as well as the participants. The system knows what each participant sounds like from previous audio artificial intelligence (AI) learning. The system also can also record and capture anything shared over screen sharing tools or emailed between the participants during the meeting. This is passive information collection situation. Another passive situation example is the system collecting and monitoring information from customer complaint calls and emails, looking for common trends and issues that could be solved through innovation solutions.

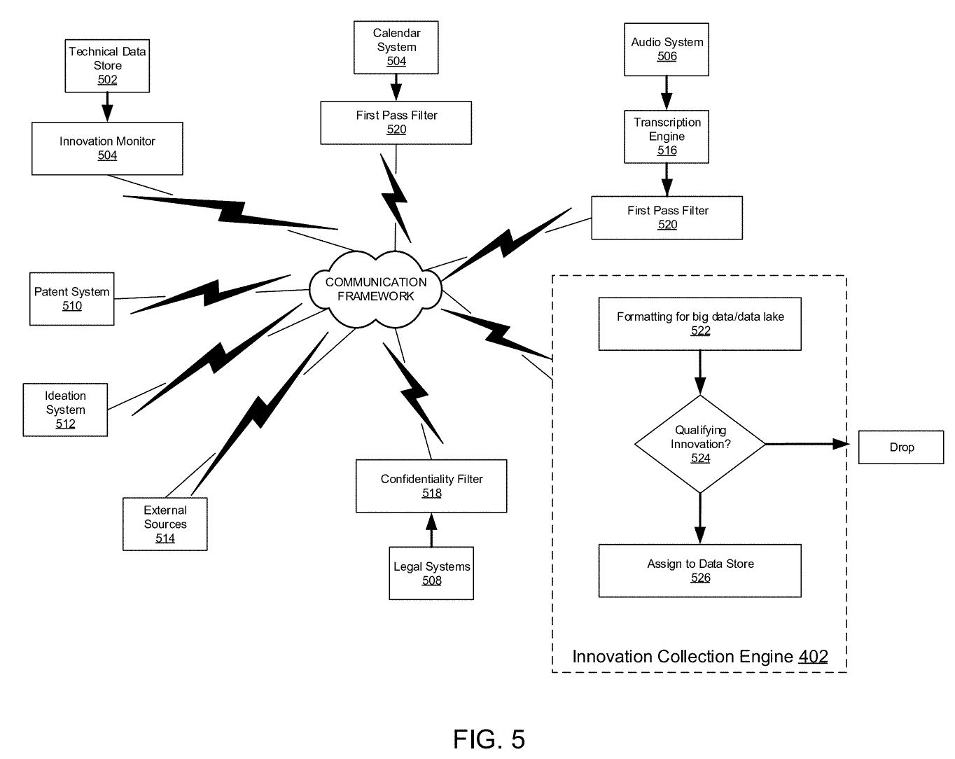

FIG. 5 shows an innovation collection system that includes innovation collection engine 402, in accordance with an embodiment. Data storage systems are shown that include various types of information. These include technical data store 502, calendar system 504, audio system 506, legal systems 508, patent system 510, ideation system 512, and external sources 514. These are just exemplary, with more examples of data storage systems described herein. Information from data storage systems is sent over a communication framework such as the Internet to innovation collection 402.

The system first may apply a specific technological filter to the data storage system. For example, FIG. 5 shows that transcript engine 516 takes information such as audio files in .mp3, .wav, or .aac format and turns those audio files into machine searchable text transcripts. Another example shown in FIG. 5 is the confidentiality filter 518 from the legal database. Confidentiality filter 518 can perform a technological search of keywords in the files and metadata to identify and prevent transmission of highly confidential information into innovation collection engine 402. This may be done by labels in the document or information related to confidentiality, attorney client privilege, or other such labels. The web crawler that is connected to external internet sources can also have some technological filtering aspects that could be configured. For example, the data coming into the innovation collection engine must be something that has been logged in Google™ scholar, or written by an individual who lists themselves as a professor or engineer on LinkedIn™ professional database, or must have been published in a certain collection of trade journals. These filtering techniques allow the innovation collection engine to be honed towards the needs of the operating organization.

The system may also apply a first pass innovation filter 520 at the actual data storage system. This could be a small application running at the data storage system. The first pass innovation filter takes in the full flow of data in the data storage system and only passes information on to the main innovation collection engine if the data meets a lower innovation criterion. This first pass innovation filter may be optionally not included in some embodiments.

The first pass innovation filter 520 is shown as connected between certain data storage systems and the wider intranet or internet connections. The first pass innovation filter 520 does a rough determination of what items may qualify for innovation identification. Further discussed below, this first pass may review an audio text transcript and discard any conversations that were clearly personal, such as recent doctor visits or how kids are doing in school. Alternatively, first pass innovation filter 520 may send along data that appears related to potential innovation, such as meeting notes in a calendar system that list specific technological improvements in the meeting notes of the calendar system, as opposed to just when and where a meeting took place.

First pass innovation filter 520 is shown in FIG. 5 as only being added to some of the systems. Data storage systems like the patent system and ideation system are, by definition, related to innovation, so no first pass innovation filter may need to be added in such as system.

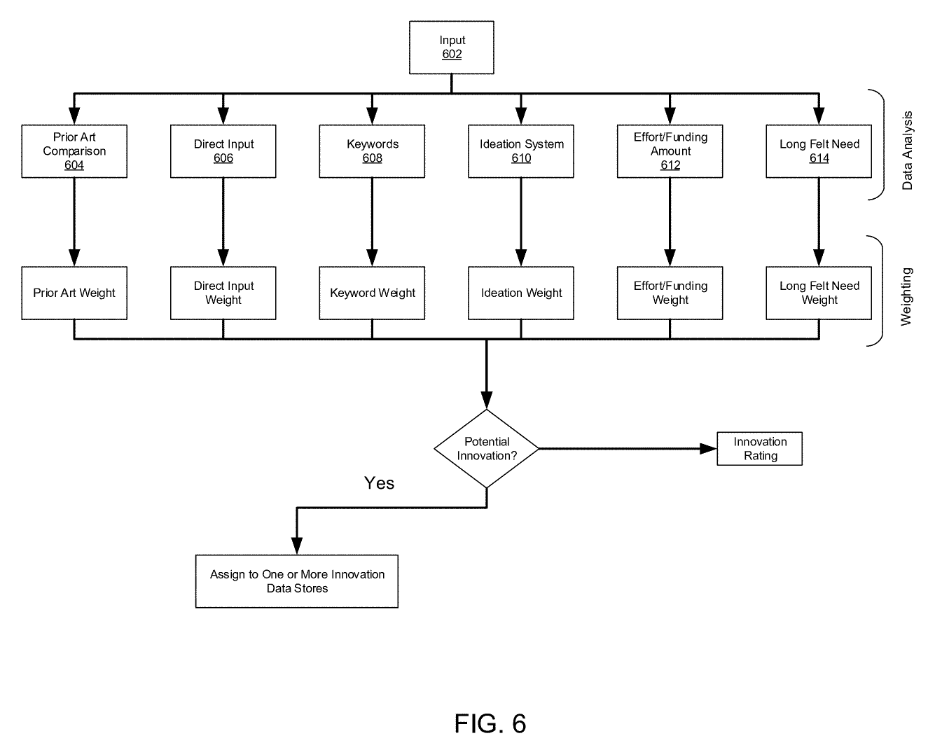

FIG. 5 shows a main innovation collection engine 402 that has a first step 522 of formatting incoming data in common formats for big data, data lake, and deep learning analysis. In step 402, then the innovation collection engine performs an analysis to determine if the information can qualify as potential or actual innovation 524, discussed further throughout. Then innovation collection engine 402 takes any information that qualifies as potential or actual innovation and assigns it to one or more innovation data store in step 526, discussed further throughout. Step 524 can be performed in an innovation identification module, further discussed with reference to FIG. 6 among other figures. Step 526 can be performed in an innovation assignment module, which assigns innovation to particular innovation data stores as discussed herein throughout.

Data storage systems are quite numerous in modern organizations today. The following are examples of such data systems and how the innovation collection engine can technologically engage each system to extract innovation related information and pull in information that would not be possible by a human in isolation.

A first example data storage system is an engineering or technical project storage system. Technical project storage systems store current projects that are related to technological advances of the organization. Such technical advances usually include some sort of innovation that is worth capturing. The system can identify the persons involved with the project, the project status, the type of technology involved and images related to innovation. Usually data is stored in presentation, document, and source code type formats in such technical project storage systems. The system can identify the persons involved in the project, the technical enhancements and drawings, as well as review pitches and documents that may include comments from leadership on what aspects they think are the most interesting and innovative. The persons may be identified by their text names in the documents and communications. Additionally, the persons may be identified through facial recognition in images related the activity. As mentioned, source code databases are one important type of technical project storage system. The system herein can turn source code into flowchart form, identify key decision points, and query users on whether those decision points constitution new, intelligent ways of processing data for potential innovation capture.

A second example data storage system is a marketing or sales storage system. A marketing or sales storage system may include files that relate to how product descriptions are communicated to customers and the general public. Usually in such files the marketing or sales information includes highlights of key features and innovations that customers should take note of, and potentially make a purchasing decision based therein. These are key indicators the innovation collection engine can hone in on to find innovation.

A third example data storage system is a manufacturing computer system and related systems for ordering parts. These systems track successes and failures in the manufacturing process, including the success and failure of individual parts as well as of how systems are working together. The innovation collection engine can pull at least two types of innovation information from such systems. The first is identifying new parts or process steps. New parts included in a manufactured good or new processes used to manufacture the good are areas of potential innovation to be noted. The innovation collection engine can perform a parts list comparison between two models and identify the new components as potential innovation laden components. A second type of innovation to be pulled from a manufacturing computer system and related systems for ordering parts is failure issue identification. Things go wrong, and innovation may be needed to solve the problem. If a certain part keeps failing and new instances of the part must be sent and installed at customer sites, this can identify a failure issue worth investigating, for example. This gets to not identifying completed innovation, but needed innovation, also called white space. White space identification is very vital to organizations so they can keep innovating over the competition and over problems they may be experiencing. White space identification is discussed further herein.

A fourth example data storage system is a budgeting or finance database or set of data files. Where money is spent, priorities lie. Thus, the innovation collection engine can use the data on which projects and products have high funding to identify potential areas for innovation. Revenue data files also show what features customers are paying more money for, so that is an indicator to protect any related innovation more highly as it is a feature competitors would be likely to copy. Further, an understanding of the patent budget for an organization allows the innovation insights engine to more accurately suggest times when certain innovation protection actions should best occur to help the budget, as discussed further below.

A fifth example data storage system is a legal database of contracts, legal entities, and legal issues. Many collaboration and development agreements that are stored in such legal databases include work statements of innovation activity between entities. These statements outlining specific innovation to be created are a specific area that the innovation collection engine can hone in on key areas of innovation. Further, contracts can quickly be searched for sections on intellectual property and innovation, and the system, such as in a first pass innovation filter, can discard sections on limitation of liability, choice of law, and other legalese not related to innovation. In addition, some contracts are patent licensing contracts. If the system detects such a header on a contract, it can pull in the specific patents or intellectual property involved and mark any related innovations in the system as higher ranked based on this information—a task done by the innovation insights engine with the patent numbers of the licensed cases identified by the innovation collection engine.

A sixth example data storage system is a human resources database. The relationship between humans in an organization is helpful to determine innovation. The job titles and role descriptions for employees are also a ripe area to determine which individuals to focus on for innovation collection. Additionally, the innovation insights engine is helped by knowing relationships between individuals and how teams are composed. This allows the innovation insights engine, for example, to determine how much innovation has been documented per team. In addition, external online human resources and recruiting databases are an important source of information for the innovation insights engine to pull in connections between individuals across the industry.

A seventh example data storage system is an audio system. Audio systems are included in every desk phone, computer, microphone on a security camera, smart phone, and conference room these days. These can be actively listening when in use or passively listening when not officially in use. Such audio systems can pull in all sorts of information that people do not have enough time to write down in other forms. As mentioned above, the system of FIG. 5 has software to turn audio recordings into searchable text transcripts for the innovation collection engine to review. Further, through deep learning and artificial intelligence systems, the systems and methods herein can learn what specific individuals sound like to automatically ascribe certain aspects of the audio transcript directly to the person speaking.

An eighth example data storage system is a video system. Video systems include smart phones, computers with cameras built in, video conference systems, security camera systems and other similar camera systems installed in a facility. These systems can capture things like drawings on a white board or piece of paper, visual insights of opinions and other visual factors that can help identify innovation. Three-dimensional camera systems, also known as stereoscopic, can also scan in real world objects and generate three-dimensional computer models that can be stored as part of innovation identification as figures in pre-populated disclosures.

A ninth example data storage system is a virtual meeting system. With persons meeting across the globe, virtual meeting systems capture data that is shared in chat windows, shared camera feeds, shared screens of computers, participant lists, meeting topics, meeting minutes, and more. Innovation can be identified in such virtual meeting systems similarly to how it is identified in in-person meeting systems.

A tenth example and highly important data storage system is email and chat services. All the communication flowing between people that is collected digitally holds many indicators of innovation and related innovation discussion. Further, such communications may have attachments that include further innovation information for capture. This can also include social media systems both within the entity and on the public internet. The types of frank feedback and comments communicated on such systems can be valuable in knowing true customer and employee thoughts on a product, service, or other areas in need of innovation. Thus, the innovation collection engine connected into email, chat, and social media services.

An eleventh example data storage system are calendar systems. Calendar systems know where people are, what they are talking about, how long they talked about it, and what the agenda for the meetings might have been, including attachments. These are important innovation indicators. For example, if one topic has had twenty meetings in one month, the system can propose it as an area for innovation identification.

A twelfth example data storage system is a computer hard drive or computer memory of every individual in the organization. These hard drives and memory may be physically in their computer devices or connected via an online service to a server or an internet cloud backup service. All of an individual's files are ripe areas for review by the innovation collection engine. Files are also stored in folders, tagged, categorized, and have other metadata that helps the innovation collection engine and innovation insights engine draw connections and conclusions.

A thirteenth example data storage system is an intellectual property data system. Intellectual property data systems are directly related to innovation. This can include patent databases tracking the entities own patent filings, copyright databases, trademark databases, trade secret tracking databases, patent clearance databases of project features and related innovation, disclosure tracking databases, litigation databases, intellectual property licensing and monetization databases, prior art databases and more. These may be internal to the entity or also pulling in information from subscription and other online intellectual property systems. Additionally, many companies and government agencies have ideation systems that allow people to submit innovation ideas and allow others to rank, like, or bump up the ideas that they like. These are specific data systems around innovation that are important for the innovation collection engine.

INNOVATION IDENTIFICATION

Systems and methods of various embodiments take in data from data storage systems such as those mentioned above. Then the systems and methods analyze the data to identify innovation. This innovation may be protectable in the form of legal trademarks, patents, design patents, utility model patents, trade secrets, copyrights, or other forms of intellectual property. In working to find potential innovation, the systems and methods of various embodiments are seeking to find new and interesting ideas.

As discussed above, certain embodiments may include a first pass innovation filter that filters out data that has a high probability of not being related to the organization and/or innovation. For example, a security camera takes in video and audio of two people having lunch. The video of people eating would be cut by the first pass innovation filter, but the conversation the people were having may be allowed through the filter if it was organization related or related to innovation.

FIG. 6 shows a system and method of determining potential innovation, according to an embodiment. FIG. 6 details some of the inner processes of the innovation collection engine, according to an embodiment. Data input 602 into innovation collection engine 402 and is directed to one or more analysis modules, or steps. The analysis modules analyze the incoming data from various perspectives. FIG. 6 shows these analysis perspectives as prior art comparison 604, direct input 606, keywords 608, ideation systems 610, effort/funding amount 612, and long felt need 614. Others may be added and some may be subtracted. The results of each of these modules is weighted based on its relevance and importance to the specific entity or situation. Such weights can be tweaked manually and/or be automatically altered through an adaptive artificial intelligence system which can include a deep learning neural network. Deep learning may include convolutional neural networks that can include the steps of convolution, rectified linear units, and pooling to fully connect layers to support data classification. Machine learning may be used in some embodiments.

The analysis of FIG. 6 provides a result as to whether data may include potential innovation for capture. If so, the data, or the relevant portion thereof, is assigned to one or more innovation data stores. Thus, FIG. 6 shows that identifying innovation can include applying a weighting function to the output of each comparison of the general data to innovation criteria; and identifying the general data as innovation data if the combined weighted outputs from each comparison exceed an innovation threshold.

FIG. 6 shows an innovation rating step. Based on the disclosed weighting and analysis, the data can be assigned an innovation rating in some embodiments. The innovation rating is a quality metric as to how strong the innovation collection engine thinks the data is from the innovation standpoint. The innovation rating is generated by a combination of analyses from different analysis modules, then that analysis is weighted and a rating is output. For example, if an idea is highly funded AND team members rate it high in the ideation system AND the prior art comparison shows the idea as strong, the system can take the totality of these separate analysis and issue a high innovation rating for a given idea or data stream. Another example is an idea that meets a long-felt need of customers AND an intellectual property committee rates the idea as strong AND the keyword analysis shows the chief technology officer saying the idea is “highly innovative”, then the system can give the idea a high innovation rating.

Thus, the innovation identification module, or steps, shown in FIG. 6 performs innovation analysis the general data for one or more of evidence of strength over prior art, direct input of innovation, innovation related keywords, high ratings from an ideation system, amount of effort or funding related to the general data, and long felt need. Further, the innovation identification module applies a weighting criteria to each of the innovation analyzes; and outputs a recommendation of potential innovation of the general data based on the innovation analyses and respective weighting applied.

In some embodiments, if the innovation rating is sufficiently high, the system might automatically generate a disclosure, rate the disclosure as patentable automatically, and automatically send the disclosure to a patent attorney with instructions to draft the patent application. And in some embodiments, the system may include the functionality to automatically generate a draft patent application and drawings based on the disclosure so that the human involvement would only need to be the final review of the patent application (or trademark application or copyright application, as applicable). Thus, the innovation rating feature can be very valuable in saving the time of individuals in the organization. Further, organization bureaucracy does not slow down the protection of innovation in such a scenario.

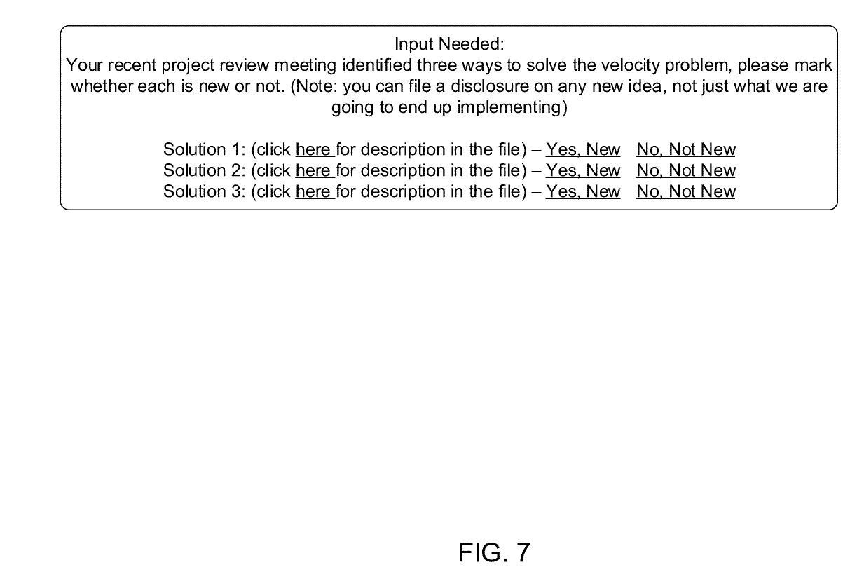

One innovation analysis perspective is direct input. Direct input is an individual actively telling the innovation collection engine that something is innovative. Individuals can do this of their own volition, but can also be prompted by the system. FIG. 7 shows a user interface computer screen asking the user whether specific data is innovative or not. This is useful when the innovation analysis of FIG. 6 is not as confident in its result, things having a medium or uncertain innovation rating. This is also useful if the innovation collection did not get enough information needed to make a good decision and wants a bit more information. As shown in FIG. 6, direct input can be useful in finding innovation that has not already been disclosed fully. The system can ask for edits and improvements to an idea.

Direct input can then be weighted, for example, based on who the person is giving the input. For example, system can apply a higher weighting criteria to the direct input of innovation if the user providing the feedback has either the word “chief” or “senior” in their job title and a lower weighting criteria to the direct input of innovation if the user providing the feedback does not have either the word “chief” or “senior” in their job title. And the innovation collection engine may ask multiple people for input and then weight each input separately based on the individuals giving the input and their relation to the product, project, or idea. Are they an inventor who may be biased towards innovation and getting a patent filed? Are they a neutral party such as a customer or a chief engineer? Or are they antagonistic towards the idea for some reason that might have been determined by the system through analysis of emails or meeting notes? Is the person high up the organization chart with a lot of influence or lower on the organization chart? Has the person been at the organization a long time or just a few months? These types of information can be pulled easily from HR systems and can apply to the weighting that is applied to the analysis of the direct input as shown in FIG. 6.

Another example of the innovation collection engine acquiring direct input is group input. At the end of a meeting, the system can summarize the meeting notes and ask the group which ideas may be innovative, before they leave the room. This is one way to get a strong source of innovation feedback for the innovative collection engine to use in its analysis and rating of the data and ideas coming from that meeting. Similarly, user interface screens can be presented for projects, product releases, and so forth, specifically asking for direct input.

Further, the user interface screen of FIG. 7 reminds the individual that innovative ideas are not just ones that are going to be built or implemented, but any idea that can be subject to intellectual property protection. This is an example of a useful reminder. The innovation systems and methods disclosed herein can use these useful reminders as teaching points to help raise the level of innovation awareness over time. The example shown is in a user interface window. Since the innovation systems and methods disclosed herein are connected to so many of the organizations digital systems, as noted above, such teaching points reminders can be inserted in other areas where an individual might see them. For example, if a meeting request is titled “product program review” the system could automatically attach an innovation teaching point to the bottom of the meeting request, such as “Don't forget to discuss key new features for innovation protection!” Another example is in an individual's web browser. If the system detects the internet usage of that individual as reading some technical papers on a certain topic, it can give the reminder in the web browser itself to say “how are others not fully solving the problem and what could be done to improve their systems?” These types of thoughtful prompts and reminders are great teaching points to improve the innovation culture of an organization. Many times, such small teaching points and reminders in the flow of work is more effective at raising innovation awareness than isolated focused training programs.

One innovation analysis perspective is using keywords for innovation identification. The innovation collection engine parses through the incoming data searching for certain words or phrases that relate to innovation, such as “new”, “innovative”, “important”, “delights the customer”, “game changing”, “valuable”, “key strategic investment”, “improvement”, “needed feature”, and the like. Once the system finds such keywords analyzes related context. Context understanding analyzes whether the keywords related to technological innovation or not, who communicated the keyword and their relative standing in the organization and so forth, and how often the keywords have been used in conjunction with various features and projects.

Further, the system learns through feedback loops which keywords, and which individuals, are more indicative of true innovation. For example, if person A says something is “game changing” leading to an idea being submitted for consideration and then the idea is declined for protection at the intellectual property committee review, this can be fed back in as historical data for the system to know about that person, that keyword, and that idea. Thus, the deep learning AI algorithm related to innovation identification can be continuously improved. Alternatively, if person B communicates that something is “valuable to the customer”, it is submitted, and it is then approved for patent filing, such feedback to the innovation identification module, and algorithms, provides indications to more highly rank that person, that keyword, and that idea.

These feedback loops relating to which ideas, products, people, and keywords affect the weighting values applied to the keywords analysis in FIG. 6. Weighting the outputs of the keywords analysis helps to determine the relative strength of an innovation indicator coming from the keywords analysis. Higher weighting may be given to keywords originating from folks who, for example, have the title of “Intellectual Property Counsel” or “Patent Counsel” or “Chief Engineer” or “Chief Executive Officer”. Lower weighting might be given to keywords such as “cool” or “neat feature” as opposed to higher weightings for keywords such as “game changing” or “large customer impact” or “key innovation”. Thus, weighting and ranking of keywords analysis is helpful in determining potential innovation.

One innovation analysis perspective is using ideation systems. Ideation systems allow folks to digitally submit ideas for consideration by others in the organization. In addition, the systems and methods proposed herein can automatically identify ideas and submit the ideas to the ideation system. Thus, if system detects a potential innovation it could automatically submit the required drawings and text information to the ideation system for internal review by a large pool of organization individuals. The innovation collection can also send out reminders to individuals in the organization, prompting them for feedback on ideas in the ideation system.

Once an idea is submitted to an ideation system, comments and votes can be applied to the idea via the ideation system. This allows individuals to give their input and feedback on the idea, including whether the idea is innovative and important. The higher an idea might rank on an ideation system can give it a higher rating for potential innovation in the innovation collection engine and innovation identification module, as shown in FIG. 6. Further, the comments related to ideas in the ideation system can be collected and analyzed by the innovation collection engine through the analyses such as discussed herein.

One innovation analysis perspective is analyzing amount of resources applied to a certain product, project, or idea. The amount of resources of an organization are generally the number of employees, amount of employee time, or the amount of funding. If the innovation collection engine detects that many employee meetings are discussing one topic, it can identify that topic as potential innovation. If the innovation collection engine detects from a financial file or database that certain technology projects have allocated over a threshold for spending, it can flag those projects as potential innovation. Over time through feedback loops, as mentioned above, the innovation collection engine can modify the weights given to certain metrics related to amount of resources analysis. Further, the weights applied to the amount of resources analysis can also be changed based on the type of resource and the individuals involved. For example, if the amount of resources analysis has found that the chief scientist has spent a half year and many meetings focused on one topic, there is a stronger weighting that that topic is innovative. For example, if one digital technology file stored in a document management data storage system, such as a product drawing or feature implementation document, has been updated over 30 times, there is likely innovation to be captured there. These are examples of analysis the amount of resources being applied to a topic and then identifying potential innovation through such analysis.

One innovation analysis perspective is analyzing prior art. The prior art, or technology, analysis can be of both internal and external technologies. The prior art analysis can find previous technologies and compare those previous technologies with current project, product, or ideas in the organization. The prior art analysis can be provided such prior art by individuals, as mentioned in meetings or emails for example, or it can perform automated searching as discussed below. If the changes between the previous technologies and current technology ideas is significant, the system can mark the change (i.e. improvement idea) as potential innovation as shown in FIG. 6.

For an internal example of prior art analysis, the innovation collection engine is aware of the 1.0 release of the organization's product. The organization is bringing forth release 1.1 with a changed feature. The prior art analysis can then compare to find the change between 1.0 and 1.1. Then, an analysis can be performed on the change to determine whether it is innovative. Another example of analyzing internal prior art is analyzing the parts database for changes. If new parts are being added to a product or service, something has changed that may include innovation to flag for review. This analysis on the change can be automatic through methods discussed herein as well as a direct input questioning of the product manager or technical expert.

For an external example of prior art analysis, the innovation collection engine can poll online services that specialize in innovation documentation, such as trade journals, conference websites, and patent services that do patent landscapes and prior art searching. This polling of online services can be done through whatever mechanisms the online service requires, such as keyword searching, technology filtering, and the like. The prior art analysis can then compare the current technology ideas within the organization against the located prior art for potential innovation identification as shown in FIG. 6. It may also prompt users if the system has identified a specific question between a prior art and the potential innovation. This is another way of getting direct input of innovation when comparing against specific prior technologies.

One aspect of prior art analysis is image analysis. Discussed above is the ability of the innovation collection engine to parse text.

This is an especially helpful feature in finding ornamental design innovation that is subject to design patent protection. For the industrial designs of new products, they can be analyzed versus the prior art by the innovation collection engine and then the system can recommend whether the industrial design is potential innovation for intellectual property protection.

One innovation analysis perspective is using felt needs of organizations teams, customers, and regulators. If a field engineering team feels it needs a feature to better service a product, then the ideas related to such a feature could be potential innovation. If a customer communicates a need for a product or service, then the ideas related to such a need could be potential innovation. If a government or other agency expresses a need for a product or service to perform a certain way as mandated by law, regulation, or standard, then the ideas related to such a need could be potential innovation. For example, seismic standards, gas mileage regulations, FDA regulations, and many others may dictate constraints to an organization. Meeting such constraints is often an important area for innovation creation. Thus, the felt needs analysis of the innovation collection engine is useful in determining potential innovation.

Needs can be collected and identified via many sources, such as emails from sales teams, customer forums, social media posts, customer visits, field engineer feedback, government regulations posted on external websites, review websites of the product, and others. All of these types of feedback sources mention specific strengths and weaknesses of the product or services. The mentioning of strengths can tell the innovation collection engine where innovation may be found. The mentioning of weaknesses can tell the innovation collection engine where white spaces may be found. All of this data is then analyzed and weighted in the innovation collection engine as shown in FIG. 6.

In some cases, an entity might decide that customer related needs and features are the highest priority. Thus, the weighting applied to the customer needs, i.e. long felt need 614, can be directly or indirectly raised such that ideas from this category are ranked highly when determining potential innovation.

Weighting of needs can be done based on the organization having the need as well as the potential timeline of requirement. For example, if the timeline to have an automobile travel fifty miles per gallon is ten years away and the organization solves this need now, the innovation collection engine can give a higher weight to this idea than an idea that meets a thirty miles per gallon requirement that is two years away. The idea that solves the tougher problem, as determined by the innovation collection engine, would get a higher weighting when identifying potential innovation.

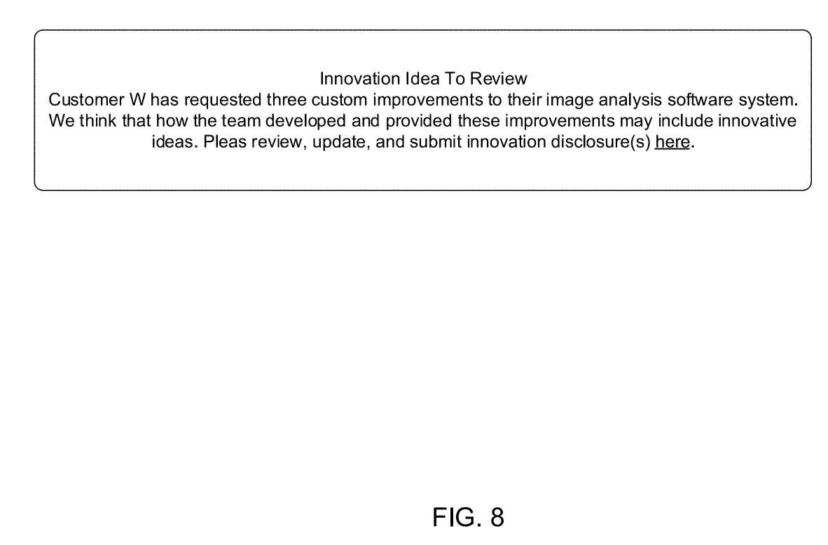

FIG. 8 shows a user interface screen, according to an embodiment. A customer has requested specific improvements to their product or service, and the systems and methods herein identify the way the organization did the improvements as potential innovation. The system automatically identifies the potential innovation using the innovation collection engine, generates a disclosure for review through the innovation insights engine, and provides a prompt for the user to review through the innovation insights engine. Thus, the user of the system within the organization, without any additional innovation effort, can review the auto-generated digital innovation disclosure, edit the innovation disclosure as needed, and then approve it for intellectual property protection.

In the specific example of FIG. 8, the innovation collection engine has pulled in information from Customer W phone calls to the customer service representative to document the improvements requested. The innovation collection engine creates an innovation database related to the customer and loads the customer requests into the innovation database even before a solution is found, because the customer is identifying white space needing innovation. As time passes, the innovation collection engine notes calendar meeting activity related to the customer and pulls in discussion transcripts and related people involved with solving the customer problem. The innovation collection engine further pulls in the computer software code from the customer-related software code repository. The software code that is timestamped as changed in certain date ranges during the improvement work is captured in the innovation database. The innovation collection database notes the improvements have been provided to the customer from an email recorded from the organization to the customer. The innovation insights engine then pulls the relevant information noted above from the customer specific innovation database and automatically generates an innovation disclosure from the data, including indicating the source of the data. The innovation insights engine then provides the user interface screen of FIG. 8 to a user in the system, such as one of the inventors, an engineering manager, or the customer relations specialist for Customer W.

INNOVATION DATA STORE

As shown in FIG. 4 and discussed above, the innovation collection engine creates and assigns data related to potential innovation to one or more innovation data store. FIG. 4 shows examples of data store specific to an inventor, a team, a technology area, a project, a product, and a customer. The innovation collection engine can understand these relationships because of the myriad of data storage systems it pulls from. For example, the human resources data storage system can give information related to the members on a management team and how those members are connected to each other, while a project document stored in a new product release database might list the cross functional team members on a product team. The fact that the innovation collection database can determine both types of teams by looking at different data storage systems makes the system more robust and useful to organizations.

As another example, some projects are high profile and are documented well, making it easy to capture innovation for most organizations. But the innovation collection engine, according to one or more embodiments, can detect smaller projects and product tweaks that might “slip through the cracks” of innovation capture, such as the example given with FIG. 8. In both situations, an innovation database was created to track the projects, whether high profile or low profile. And as discussed in relation to FIG. 6, the system can prioritize projects based on analyzed the factors shown, including effort and funding amount. The innovation collection engine can assign a datum to multiple innovation data store. For example, Inventor J has a good idea for Project M. The details shared about the good idea, such as drawings and description text, can be assigned to both the Inventor J innovation database and the Project M innovation database.

Individuals in the organization can directly view the innovation data store as they like. For example, an inventor can view their personal innovation data store to look for things they have worked on and potential ideas to submit. They can also tweak the information to potentially remove less relevant information and add additional details to ideas. Such innovation data store can become a great archival and information storage system on top of the impact it can have for the innovation pipeline.

INNOVATION INSIGHTS AND ANALYSIS INTRO

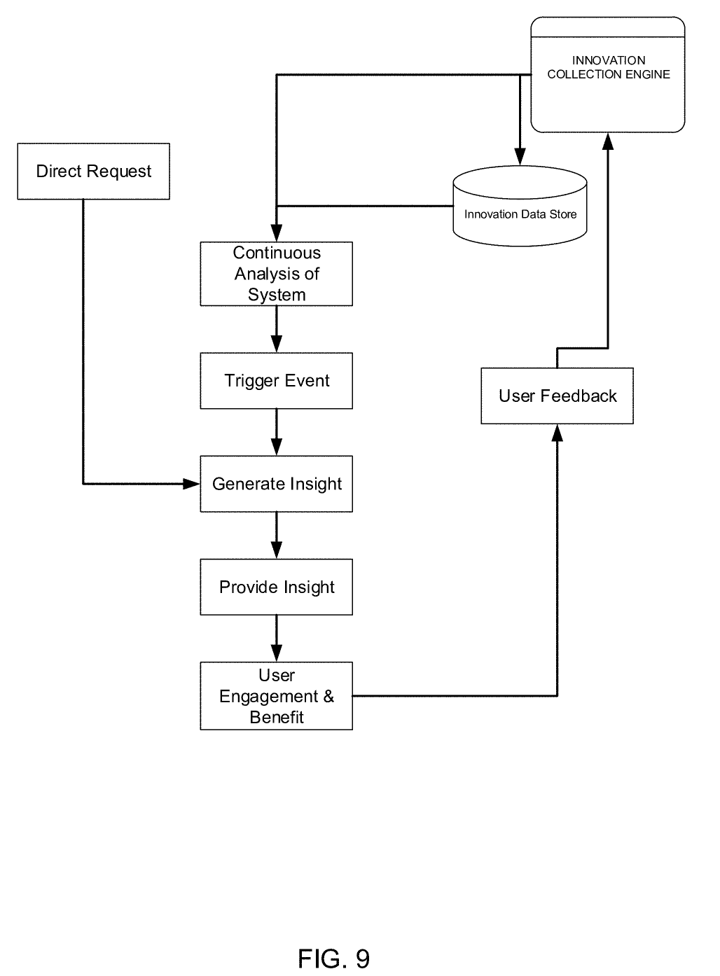

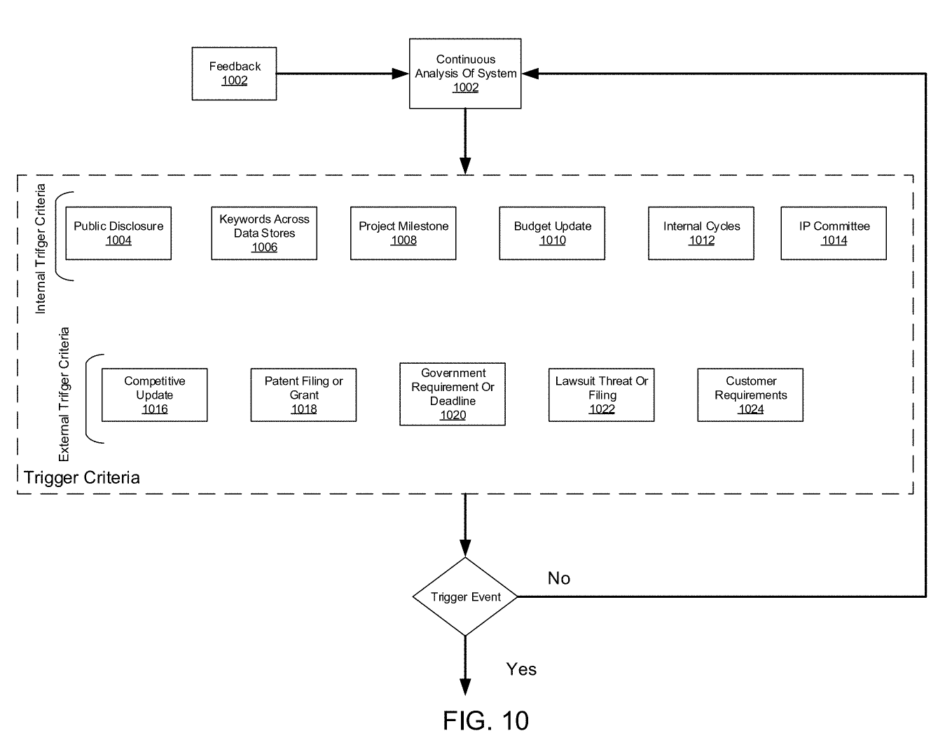

FIG. 9 and FIG. 10 show flowcharts outlining steps taken by the innovation insights engine, according to one or more embodiments. The innovation insights engine provides analysis and insights to help organizations better protect and manage innovation.

FIG. 9 shows the innovation insights engine continuously analyzing the system and data therein, including in the innovation data stores. If a trigger event is detected, as discussed further with respect to FIG. 10, the system generates an innovation insight. An innovation insight can be one of many types of insights depending on the situation, as discussed with reference to FIG. 4 and further throughout. The insight is then provided to one or more users, providing innovation usefulness and benefit. The user then performs an action, makes a decision, or chooses to not act. The innovation insights engine takes the user's response and converts it into user feedback to be provided back into the system, to the innovation collection engine, the innovation insights engine, or both. Since the system is constantly improving its artificial intelligence analysis through deep learning neural networks, such feedback is used to continually improve the understanding of innovation, the correct trigger events, and user preferences.

FIG. 10 shows a trigger event flowchart, according to one or more embodiments. FIG. 10 further expands on the “trigger event” step in FIG. 9. Many types of events could trigger an innovation insight, and the system is programmed to analyze the incoming data as well as innovation data store for such triggers. FIG. 10 lists some examples of trigger criteria, and herein described is a partial list of the types of analysis may be conducted. Trigger criteria may include, but are not limited to, a public disclosure; keywords across data stores; a project milestone, a budget update; an internal cycle; an intellectual property committee decision or request; a competitive update; a patent filing; a patent grant; a government requirement or deadline; a lawsuit threat or lawsuit claim filing; or customer requirements.

Public disclosure trigger 1004 analysis notices when a public disclosure will be made or has been made to alert the user to potential patenting bar dates or confidentiality breaches for trade secrets. Keyword trigger 1006 analysis notices innovation ideas that should be linked across different groups in a large organization, if an innovation idea is urgent for some reason, or a competitor has newly released some information that would be noteworthy to identify prior art or white space insights. Keyword trigger 1006 analysis also is on the lookout for specific keyword phrases such as “please submit that idea for innovation protection” and the like. If there is one phrase that is most useful in an organization, it can be taught to people to use for the system to most easily detect and understand the intent of innovation collection and protection. Project milestone trigger 1008 analysis notices when certain thresholds of project or product development, such as project milestones or deliverable dates, have been made to provide related innovation lists or prompts and other innovation insights to said project or product. Budget update trigger 1010 analysis notices if the patent budget is high or low, giving appropriate innovation insights to help balance the budget. Budget update trigger 1010 analysis also notices when large amounts of research and design budget has recently been spent, thus potentially indicating the need to review for related innovation. This can help capture innovation being developed by third parties under contract, such as works made for hire. The system can detect when payments are made and alert users to review any potential related innovation.

Internal cycles trigger 1012 analysis notices various internal milestones and events that may trigger innovation review. For example, in certain countries teams may take extended summer holiday. In these instances, innovation insights engine 404 may detect a trigger on early summer to harvest and get inventor input on all innovation ideas before the inventors take their extended summer holiday. Other cycles may include certain management reviews for innovation protection and review. These can be set up manually by a user or can be detected automatically by the system reviewing certain meeting notices and presentation files that refer to innovation review and future planning. One standard cycle entities may have yearly targets, either by calendar year or fiscal year. The system can determine, as the deadline approaches, how if the targets are met and prompt for more innovation if there is a shortfall.

Intellectual property committee trigger 1014 analysis notices when decisions are made or need to be made by the intellectual property committee or patent evaluation board. For example, if the intellectual property committee reviews an innovation idea and decides “more prior art search needed”, the system can see that trigger and automatically tell the innovation collection engine to poll the prior art data storage system for such information. The intellectual property committee might have many other spoken or written insights from their meetings that trigger all sorts of innovation related activity to happen, from filing of intellectual property applications, to specific idea improvements that can be added to innovation data store, to potential dates of interest like noting when a certain inventor will be leaving the organization to go to a competitor.

Innovation insights engine 404 continuously examines for external triggers as well. Competitive update trigger 1016 analysis notices when competitors make certain public announcements, published papers, or filings with the government. These public announcements and filings are analyzed by the system for certain innovative features in competitive offerings. Further, if certain key innovators are identified in such competitive analysis, alerts may be set up around that individual as discussed further below. Additional external triggers might be a patent filing or patent grant 1018, governmental requirement or deadline 1020, lawsuit threat or filing 1022, as well as customer requirements and deadlines 1024. These types of external triggers may provide a reason to provide an innovation review, insight, and protection action.

The disclosed trigger analyses shown in FIG. 10 are examples of events that would trigger an innovation insight to be generated. Alternatively, as shown in FIG. 9, a user can directly request an innovation insight. For example, a user can request an innovation summary related to a project or engineering team. As another example, discussed further below, a user might indicate that an innovation brainstorm is upcoming around a specific technology area and may request related innovation and prior art from the innovation insights engine.

INNOVATION DISCLOSURE AUTO-CREATION

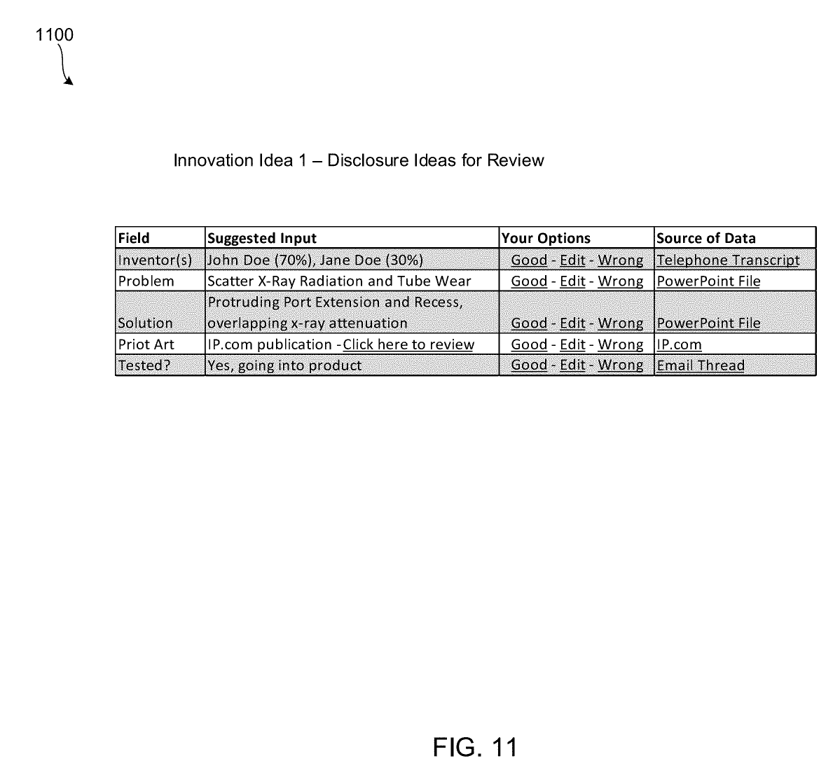

A first, very practical, and useful insight is a pre-populated innovation disclosure. FIG. 11 shows an example pre-populated innovation disclosure generated by an innovation insights engine, in accordance with an embodiment. An innovation disclosure may also be referred to as an invention disclosure, innovation report, or invention report.

FIG. 11 shows innovation idea one presented as a disclosure idea for review. FIG. 11 shows a grid of information including columns such as innovation disclosure field, the input that the innovation insights engine suggests for that field, options for the user to approve, edit, or reject the suggestions, and the source of the data that the suggestion was drawn from. The user can click on the source link to go directly to the source data and dig into the source data in more detail. FIG. 11 can show the data presented as text, images, and digital links.

The source of the data column shows that the data source can come from a myriad of sources and all be combined into a single innovation disclosure, as discussed above with respect to the innovation collection engine. The information for such a pre-populated disclosure generally, but not always, would come from a single innovation database. The information pulls in items from many data storage systems into one innovation database around the innovation that includes innovation idea one, for example. Gathering, filtering, and collating data from the input sources helps the pre-populated disclosures include much more information than if the information was just coming from one source. For example, many innovation disclosures previously are just an innovator typing their thoughts in the moment. Since the system can analyze information that the innovator may have forgotten or never known, the innovation insights engine can provide a more thorough and valuable pre-populated innovation disclosure. Some organizations are very big and a single innovator or group of joint innovators may not be seeing the full innovation picture. The systems and methods disclosed herein help the innovation analysis and protection procedures of such an organization see more of the full innovation picture.

Generating pre-populated innovation disclosures has a large benefit for organizations. Skilled innovators within an organization are generally very busy perfecting innovations themselves and often do not have the time to properly document and submit innovation information for intellectual protection. A system that can automatically collect, analyze, and provide pre-populated innovation disclosures saves a lot of time and effort for an innovator. The innovator can then just approve, edit, or decline the information, which is generally easier then documenting the idea from scratch. This also provides the organization with many more innovation disclosures to help protect ideas that otherwise may have been lost amid the large amount of activity of the organization.

Further, innovation documentation systems that do not require manual typing are helpful for some innovators. The system disclosed herein can be used to allow the innovator to simply stand in a conference room, speak normally how they would speak in conversation and draw some of the ideas on a white board or chalk board. The system can then collect the innovation through audio and video data gathering systems, assign it to an innovation database, and provide innovation insights such as pre-populating an innovation disclosure, all without the innovator having to type very much. An office room could have a button in the room called “collect innovation”. An innovator or group of innovators could come in the room, hit the button and then just have a stream of consciousness flow of their innovation idea in audible words and sketched drawings. They could then let the innovation systems and methods disclosed herein format and populate a disclosure submission for them. This is beneficial for many users.

Innovation disclosures can have many fields associated with them. The following is an explanation of the types of analysis that are performed by the innovation insights engine to pre-populate various fields in an innovation disclosure. The examples of how to determine information for each various field is a non-exhaustive meant only to give a non-limiting list of specific ways the technological systems and methods could operate.

One field of a pre-populated innovation disclosure could disclose the inventors or innovators of the idea. The inventors can be determined from the folks who spoke about the idea in relevant meetings, the authors section of related documents or presentations, product managers of a certain project, or those who emailed the most technical information about the innovation idea. Further, once a solution has been clarified, the system can retroactively go back and determine which individuals initially presented the solution. Further, the system can identify joint inventors that discussed the idea in person, via email, via instant message, and other digital discussion mechanisms.

One field of a pre-populated innovation disclosure could disclose the technical problem in need of solving. This can be determined from project documentation, customer request emails or submissions, or overheard from product testing or feature discussions. Another area that may define technical problems are industry conferences and the topics the relative experts are tackling and discussing. Another area that may define technical problems is the ideation system of the organization, where a user may submit the problem and challenge others to provide solutions.

One field of a pre-populated innovation disclosure could disclose the solution to a technical problem. These solutions are often found in technical documents, engineering files, CAD (computer aided drawing) files, images, sketches, software code, and computer user interface screen shots. Additionally, when trying to describe the solutions found, the innovators might put an explanation in a presentation for dissemination to a larger audience. The system can also detect when a solution is said to have been found, but the system maybe cannot find where it is documented. The system may note in the pre-populated disclosure “Bob said on the September 19^{th} call that a solution had been found that included metamaterial technology. The system is unable to locate the documentation for the solution, please submit it by clicking on this link.”

One field of a pre-populated innovation disclosure could disclose the related prior art. Prior art identification systems can be external services, internal understanding of the organizations own portfolio, and searches by individuals. See further below on the discussion of prior art identification and analysis.

One field of a pre-populated innovation disclosure could disclose related individuals to the idea. These are individuals who are not inventors, but may have an opinion or stake in the idea. For example, project managers, chief engineers, chief technology officers, technology directors, sales people if the idea is related to their customer and so forth. This can be identified by related emails and discussions around the idea. Their interest in the idea can be identified and then they can be properly notified of the disposition and potential protection of the proposed innovation idea.

One field of a pre-populated innovation disclosure could disclose the status of testing of the idea. The system can see what has been purchased related to building and testing prototypes. Further, testing logs and related video footage may be used. This type of testing information can be helpful in an innovation disclosure to help give the decision makers more data on the technical merits of the idea before they decide to spend money on certain types of intellectual property protection such as filing a patent application in one or more jurisdictions.

One field of a pre-populated innovation disclosure could disclose related contracts, partnerships, and joint development work. This can be detected by the domain names listed in email addresses, travel and lodging logs, contracts stored in legal databases, and meeting notes with cross organization teams in the meeting. The system can also have a teaching point listed in this section of the disclosure, reminding the innovators about laws and rules around who should be listed as an inventor and not listed as an inventor. This would help train the inventors and help to quickly ensure that only the right folks are listed on the innovation disclosure.

One field of a pre-populated innovation disclosure could disclose what information, if any, has been disclosed to third parties. This can be detected via email, text, and telephone communications. Also, if an innovator wants to present an idea at a conference or public in a publication, they would likely need to submit the idea for approval of such disclosure. If the system detects such sharing, it can check if protection for the idea has already been filed and whether an agreement has been signed with the third party around confidentiality, such as a non-disclosure agreement. Warnings can be provided to the user in cases when issues may arise, as noted further below.

One field of a pre-populated innovation disclosure could disclose if there are any circumstances that merit quick action. For example, if the idea must be disclosed in an upcoming meeting, the pre-populated disclosure can specifically recommend a provisional patent filing be made. Or if an idea needs to be filed by a certain date to be included in the budget, the system can detect the budget cycle end and provide the date the decision and filing should be made by.

One field of a pre-populated innovation disclosure could disclose which intellectual property committee would be the best to decide on a particular idea. If an organization is large enough to have multiple intellectual property committees making decisions on intellectual property protection, the system can recommend which committee to route the idea to, based on internal criteria. These criteria may be in organization tables, database files, or web pages.

One field of a pre-populated innovation disclosure could disclose the recommended patent attorney or patent agent to draft a patent application for the idea. The internal patent system of the organization may list what attorney, agent, or law firm has drafted previous related ideas. Additionally, the system can see the emails of the intellectual property counsel for the organization which may include recommendations and decisions on which individual would be best to draft the patent application for certain types of ideas. Thus, to the innovation insights engine can determine who the recommended attorney, agent, or firm may be to handle the current idea in the pre-populated disclosure.

One field of a pre-populated innovation disclosure could disclose related internal ideas and submitted disclosures. For example, the system can pull from a feature list of the project and show the related ideas from the project perspective. For example, the system can show related ideas from that particular inventor. The relation to the idea can be based on which innovation database the relation is pulled from. These relations help the organization develop portfolios of intellectual property around technology areas, as opposed to only focusing on single ideas.

One field of a pre-populated innovation disclosure could disclose related comments. Related comments may be of many types, but generally pulls in comments that others have made about the idea in emails, meetings, forums, ideation systems, customer feedback, and elsewhere. Comments may include improvement suggestions, positive feedback, negative feedback, whether or not an idea is detectable, potential infringement of the idea by third parties, potential uses of the technology and related intellectual property, and notes about the priority or value of the idea to the business. Such comments are useful to decision makers such as intellectual property committees as well as the attorneys or agents drafting the patent specification.

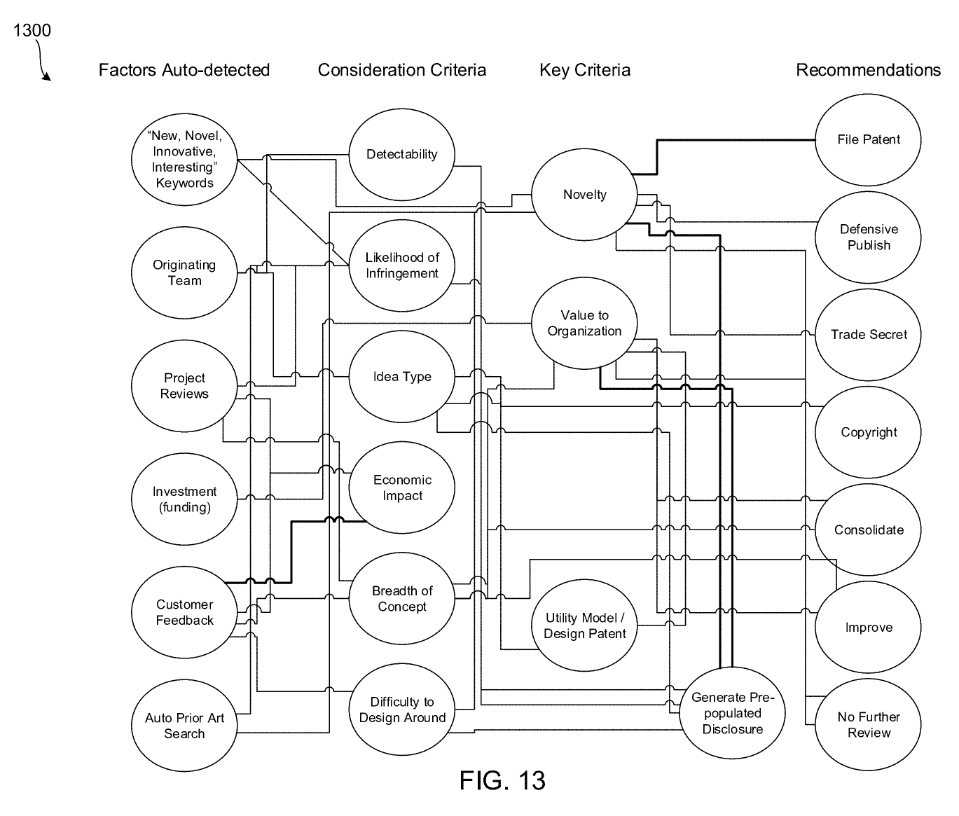

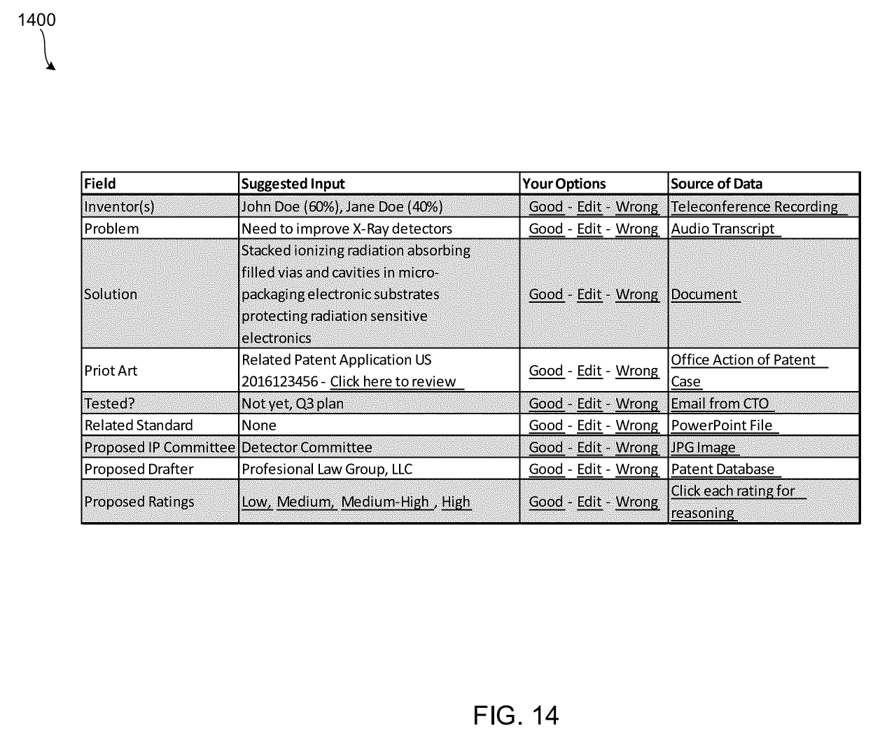

One field of a pre-populated innovation disclosure could disclose suggested decision recommendations and an artificial intelligence rating on strength of the filing. This is discussed further below in relation to FIG. 13 and FIG. 14.

One field of a pre-populated innovation disclosure could disclose suggested countries for filing a patent around the world. For example, if the system sees that sixty percent of revenue of the entity comes from Italy, it can recommend filing a patent application in Italy. Or if it sees from marketing documents that a key competitor is located in South Korea, it can recommend filing in South Korea.

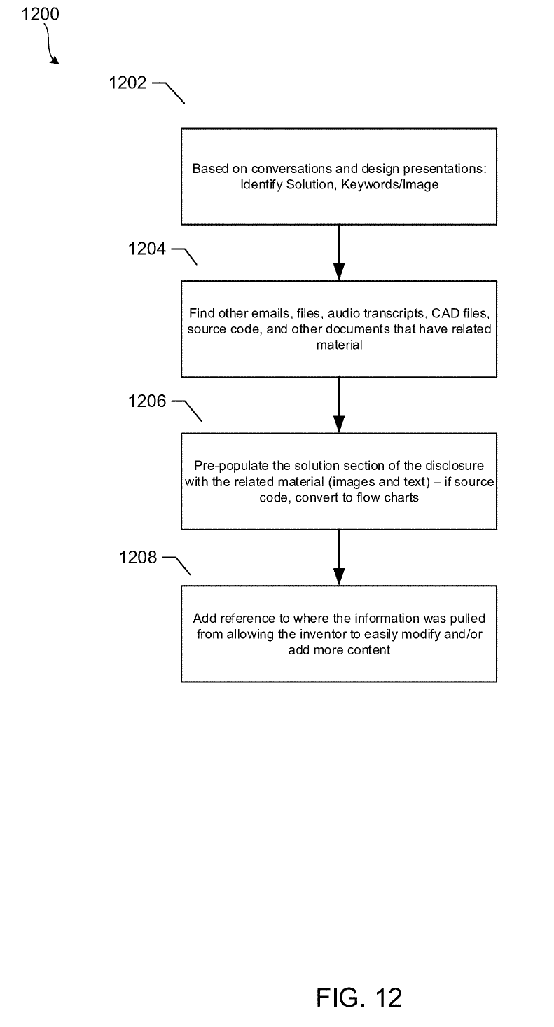

FIG. 12 shows a process 1200 that helps the innovation insights engine create a pre-populated innovation disclosure. In step 1202 a solution is identified through keywords and information shared in conversations and design presentations. The solution keywords and an example image are identified. In step 1204, innovation insights engine 404 searches for related material, generally found in related innovation data store. The related material can come from the variety of sources listed above such as emails, files, audio transcripts, CAD drawings, source code, and other documents. One example is if the solution image was originally found on slide four of a presentation, innovation insights engine 404 might also grab slides three and five. This is an example of nearby material being pulled in as potentially related. Other ways to identify related material is by keywords, semantic searching, and related image comparisons. In step 1206, such related material is used to fill the related fields in the pre-populated innovation disclosure, such as inventor, publication dates, technical problem, solution, prior art, other inventors, and more. If source code is one of the material types, the process will auto-convert the relevant source code sections into human readable flow charts, according to an embodiment and discussed further below. In step 1208, the system adds in references to the source material where it found the material for the pre-population. This is shown in FIG. 11, for example. Adding in this reference to where the information was pulled from helps the inventor easily review and add more content from that source if they chose to do so.

FIG. 13 shows an exemplary neural network 1300 for innovation disclosure decision making, according to an embodiment. The neural network 1300 may also be referred to as a patentability decision engine or an intellectual property decision engine. The end goal is give recommendations on decision making around innovation and decide when to create a pre-populate innovation disclosure. The first column of neural nodes are factors of consideration. The example nodes shown are not an exhaustive list, and the trigger factor analyses of FIG. 10 are generally included in the neural network decision making of FIG. 13. Keywords, the originating team for an idea, project review meeting conclusions, amount of financial or time investment, customer feedback, prior art search results, text in files around innovation, and other factors are considered in the first column of nodes. Depending on the type of information in a node in the first column, its output is routed to one or more neural nodes throughout the system. For example, if an engineering team is a hardware engineering team, this impacts whether or not a given idea might be easy or hard to detect, so the output of the “originating team for an idea” node goes into the “detectability” node. The “detectability” node is in the second column of nodes.

The second column of neural nodes are innovation consideration criteria. These are criteria that help give recommendations on whether a given idea has novelty and value to the organization, which are key decision making nodes shown in column three of neural nodes. Also, the innovation consideration criteria help decision making related to how to process and route innovation for the best type of protection, as shown in column four of neural nodes. And the innovation consideration criteria also influence the single decision node on whether the system should generate a pre-populated disclosure. The innovation consideration criteria can include, but is not limited to, considerations such as how detectable the innovation idea is, the likelihood that the idea will be utilized by others in the marketplace (i.e. likelihood of infringement), the type of idea, the economic impact the idea may have if commercially implemented, the breadth of idea (i.e. how widely applicable the idea is), and how easy the idea would be to design around if someone had the same technical problem. The idea type node helps automatically determine whether an idea is based in software code, an image, a user interface, a process, a method of manufacture, a brand name, a hardware design, or other categories. This is a helpful innovation consideration node when determining which type of intellectual property protection might be best applicable, as is done in column four of neural nodes.

FIG. 13 shows exemplary connections between neural nodes, showing associations and decision making impacts. The strength of each node (i.e. its influence over the neural networks decision-making) can be represented by larger or smaller nodes. And the weights each node may have towards influencing a particular node may be represented in thicker or thinner lines between the nodes. For example, the “customer feedback” node in the first column has a stronger weighted effect on the “economic impact” node than the “breadth of idea” node due to the nature of information, so the line between the “customer feedback” node and the “economic impact” node may be thicker than the line between the “customer feedback” node and the “breadth of idea” node.

The third column of neural nodes includes key decision making criteria including “novelty” and “value to organization”. These key decision making criteria are the strongest neural nodes related to decision making as to when to “generate a pre-populated disclosure”, as shown as a decision node in FIG. 13. If the influence of the various nodes in the system is strong enough on the decision node, it makes the decision to generate a pre-populated disclosure and initiates such action in the innovation insights engine, such as the steps shown in FIG. 12.

The fourth column of neural nodes includes decision recommendations, which can be included in the pre-populated disclosure or related user interface notifications to a user. These recommendations can be referred to as intellectual property recommendations and can be for patent filing, utility model filing, design patent filing, defensive publication of an idea, trademark, trade secret rating and protection, copyright protection, consolidation with another idea, improve the idea (i.e. such as adding more detail), or the decision that no further consideration should be made on the idea from an intellectual property standpoint. Based on the type of idea and the other node analyses, the system can recommend specific ways to protect the idea through legal intellectual property protections.

Feedback and continuous learning is important to neural networks. Feedback and learning into the exemplary neural network shown in FIG. 13 includes the decisions made by the intellectual property committees, patent attorneys, intellectual property counsel, management, and others. Further, the system can tweak the strength or weakness of nodes as well as the weights of connections between nodes based on the discussion and decisions of various businesses and product groups within an organization. For example, one intellectual property committee has the camera division and that more strongly favors ideas that have a strong research and development investment. Thus, the investment in funding node is stronger for that intellectual property committee. As an alternative, a different intellectual property committee might make its decisions weighting more heavily towards customer feedback, so that node of its neural network may be stronger. Thus, the neural network system of FIG. 13 might be implemented in many instantiations for various groups across an organization. Feedback and weighting continuously improve these neural networks.

FIG. 14 shows a pre-populated innovation disclosure 1400, according to an embodiment. The pre-populated disclosure is displayed on a computer user interface screen. The pre-populated disclosure can automatically be provided to a user, such as a pop up window or email alert based on one of the triggers in FIG. 10, for example. Alternatively, the pre-populated disclosure can be provided upon the request of a user in the organization. The pre-populated disclosure could have been pre-populated before the request based on a trigger event in FIG. 10, for example, and then stored in an innovation database for future retrieval, or the pre-populated disclosure can be generated on-the-fly after the user requests such a disclosure.

The system can generate pre-populated disclosures such as shown in FIG. 14 after a request for such a disclosure has been submitted. An example is where a manager knows that the engineering team has been researching a topic area such as graphene, and wants to see if the research has progressed far enough that innovation has occurred. The manager can ask the innovation insights engine to pre-populate a disclosure related to graphene research. The innovation insights engine might first check to see if there is a specific innovation database already assigned to this issue. If so, much of the material is ready to go for pre-populating the disclosure. If not, the innovation insights engine and innovation collection engine may have to search across multiple data store to pull together the information needed to pre-populate a disclosure.

A user can interact with the pre-populated disclosure using one or more computer input devices. Underlined sections in FIG. 14 show areas where a user can interact to remove, edit, or approve information in the pre-populated disclosure. The innovation systems and methods disclosure herein may at times have only some of the information needed for internal decision making and/or intellectual property filing. Some information needed may still be in the minds of innovators. Some information needed may still need to be created or invented. Thus, not all fields in a pre-populated disclosure may be have full information included.

FIG. 14 shows fields for inventor names, the technical problem, the technical solution, prior art found, whether the solution has been tested, any industry standards that this solution might relate to, the intellectual property committee that the idea most likely should be routed to, the proposed patent attorney or law firm that might be best suited to write any related patent application (i.e. proposed drafter), and proposed ratings for the pre-populated disclosure. The proposed ratings may also be referred to as proposed patentability ratings. The ratings shown are related to various criteria that the intellectual property committee might use in their decision making. For example, if a criterion is whether an idea has economic benefit, the system could give it a medium ranking if a specific customer requested the idea and a high ranking if many customers requested the idea. As shown in FIG. 14, a user can click proposed rating to see a screen that explains why the innovation insights engine proposed such a rating for the pre-populated disclosure.

One of the benefits of the pre-populated disclosure shown in FIG. 14 is the right-most column that gives source of data. Because the innovation collection engine receives data from many types of sources and is able to assign innovation related data to a single innovation database for the idea, the innovation insights engine can retrieve all the information for the idea and the originating source. FIG. 14 shows examples of sources of innovation data such as an online group meeting teleconference recording, audio discussion transcript (could be from a group meeting room, phone call, casual conversation near a recording device, etcetera), document file, an Office Action issued by a patent office of a parent case related to this idea, an email, a presentation file, an image file, a patent database, and other sources. The embodiment of FIG. 14 gives a user the ability to understand where information came from and be able to review the original source material by clicking the related link. This feature is also useful when there are multiple inventors or reviewers on an idea. Each individual might not have been part of all of the source data, but they can then see all of the source data to help bring them up to speed on the innovations across the whole project. This gives knowledge sharing benefits in addition to the innovation capture and protection benefits explained throughout.

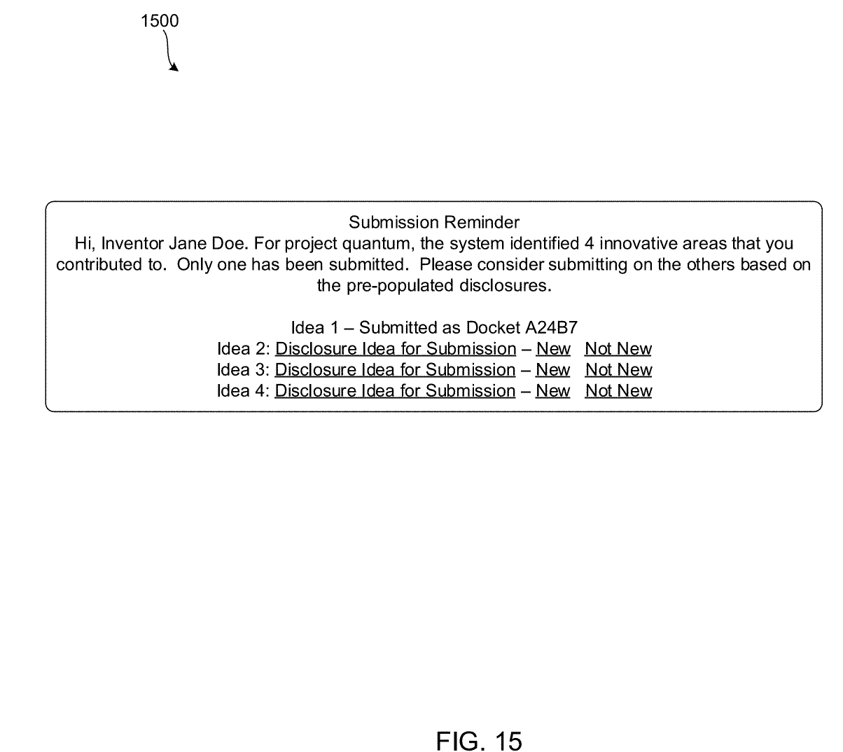

FIG. 15 shows a user interface screen 1500 for display of innovation ideas to an inventor, according to an embodiment. The innovation capture engine 402 has previously created an innovation database for the project quantum. There is a plurality of innovation ideas stored in the innovation database for project quantum, and four of them have a certain inventor associated with them, Inventor Jane Doe. The system sends a submission reminder notice to the Inventor, such as an email, pop-up screen, or webpage. This allows the inventor to see a list of the potential innovation ideas flagged in the system, to view and change the ideas, and to provide feedback to the system. The inventor can view and change the ideas by clicking on “Disclosure Idea for Submission”. Then, a user interface similar to FIG. 14 may be displayed for the user to view and change details related to that innovation.

The inventor can also give the system feedback by using the “New” and “Not New” links. The system may have flagged an idea as potential innovation based on factors in the innovation, but the user is given a chance to provide feedback on the determination. That said, the inventor may not be the sole arbiter of what is new. For example, if there are four inventors associated with Idea 2 and three say the idea is new and yet one says it is not new, the system may decide to still submit the idea for review by the intellectual property committee. Alternatively, the system may put that judgment determination on whomever is designated as the lead inventor or other factors. This feedback loop not only impacts the disposition of the current disclosure; it is fed back into the innovation collection engine and the innovation insights engine to improve the future decision making of each.

FIG. 15 shows one of the benefits of the innovation systems and methods herein. It is possible that ideas two through four may have never been captured in the system or protected with intellectual property, because the inventor was too busy or was unaware of the potential of the ideas. Because the system is continuously looking for innovation for proposal, it was able to identify additional innovation for protection.

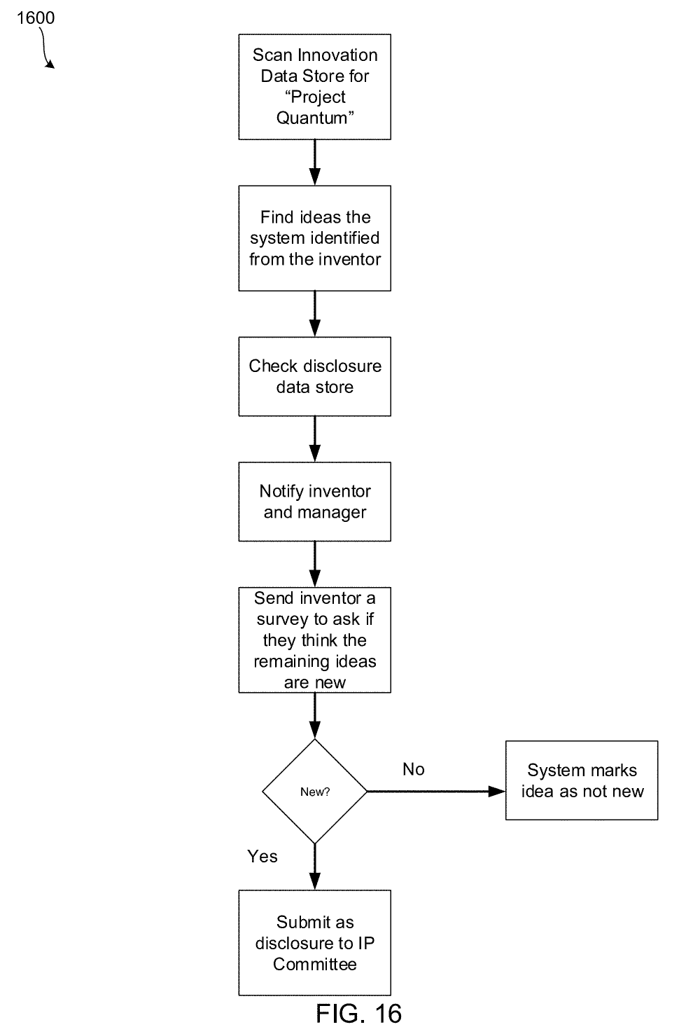

FIG. 16 shows process 1600 for generating a user interface like that of FIG. 15, according to an embodiment. The innovation insights engine scans the innovation database for Project Quantum. The innovation insights engine finds four potential innovation ideas identified for a certain inventor. The innovation insights engine checks the external disclosure submission database and finds that only one of the four potential innovation ideas has been submitted, as docket A24B7. Then the system sends an alert or reminder to the inventor asking for feedback an input related to the other three ideas. In addition, a manager or engineering leader or other inventors may also be alerted to get their input and feedback. If the inventor marks an idea has new, the idea is submitted to the disclosure database for intellectual property committee review. If the inventor marks the idea as not new, the system can mark the idea as for no further follow up, send to a manager for sign off, or to other inventors for their review, depending on the configuration. FIG. 15 and FIG. 16 are specific examples according to an embodiment. Additional embodiments are contemplated herein.

The process 1600 of FIG. 16 and the user interface 1500 of FIG. 15 can be set to be activated based on trigger events or routine intervals. For example, as the end of a business quarter is approaching, the innovation insights engine can perform a full check of any potential innovation for submission that has not received user feedback, and then provide the innovations to the innovators or others for review. Or if an engineering team has a team meeting every two weeks, the innovation insights engine can be set to provide two-week interval updates on innovation related to that engineering team. Alternatively, an organization leader such as a chief technology officer may want to see a full year innovation summary on demand, thereby giving the system a trigger to provide such a report immediately.

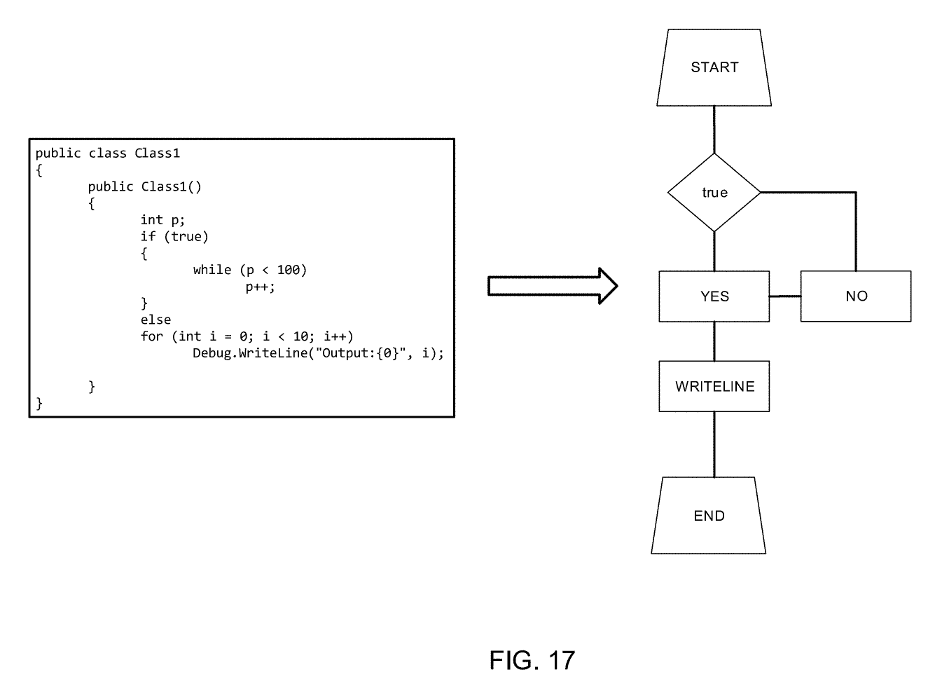

FIG. 17 shows process 1700 for automatic flowchart generation, according to an embodiment. Software code, by its nature, is not easily human readable. Further, many programming languages exist that have varying syntax and nomenclature. The innovation insights engine can take a section of software code stored in an innovation database and convert the software code into flowchart form as displayed in FIG. 17. In the right flowchart section of FIG. 17, the innovation insights engine has given square shape to steps that are internal program steps, a trapezoid shape to input or output program steps, and a diamond shapes to decision points in the program. The decision points are key points for innovation consideration as the system has to make an intelligent decision based on the knowledge it has so far in the program. Code sections such as “while”, “if-then”, and other forms of decision syntax are scanned for by the innovation insights engine to determine decision points. The flowchart then is inserted as a figure in a pre-populated disclosure, not the computer software code itself. If the user wanted to see the raw computer software code, they would click in the far-right column of the pre-populated disclosure to see the source material. Then, when presenting the flowchart for innovation review, the system can specifically ask the user to review key decision points in the flowchart, easily identifiable as diamond shaped. In addition, during the review of the pre-populated disclosure, a user can modify and update the flowchart as they prefer. For example, the code only captures what was implemented, not any future ideas that have yet to be implemented.

If an intellectual property committee or other decision maker decides that legal intellectual property protection application should be submitted to one or more government offices, the innovation insights engine can be programmed to automatically prepare a first draft of such a submission. Such submissions include utility patent applications, trademark applications, utility model applications, design patent applications, plant patent applications, and copyright applications. The pre-populated disclosure formats disclosed herein have similar format to that of such application formats the innovation insights engine can generate such a first draft legal application using legal application templates and the related disclosure information. Such a first draft could save the organization time and money. For example, a patent attorney drafting the patent application would not have to generate the patent application from scratch. Instead, using the first draft patent application provided by the innovation insights engine, the patent attorney may have to spend less time on the application drafting and subsequently charge the organization less money.

INNOVATION TRACKING

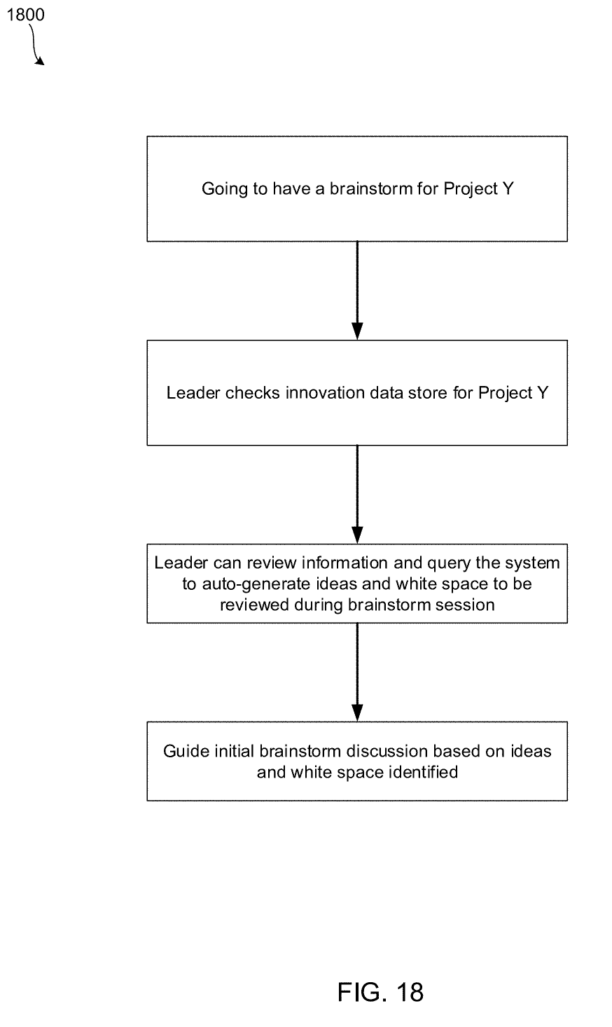

FIG. 18 shows a process 1800 of innovation support, according to an embodiment. FIG. 18 shows how the innovation systems and methods herein support innovation brainstorm activities within organizations. A leader knows an innovation brainstorm will occur for Project Y. The leader checks the innovation database for Project Y. This may be directly or through a query of the innovation insights engine. The system provides the innovations and other material stored within the innovation database for Project Y. The system can then provide pre-populated disclosures. The system can also then provide brainstorm suggestions, specifically around disclosures that need more information and white space areas, as discussed further below. For example, if three out of the four innovation ideas for Project Y only less than fifty percent populated at this time, the system can recommend further brainstorming and information around those three innovation ideas. These systems and methods provide for more productive and focused innovation brainstorm sessions.

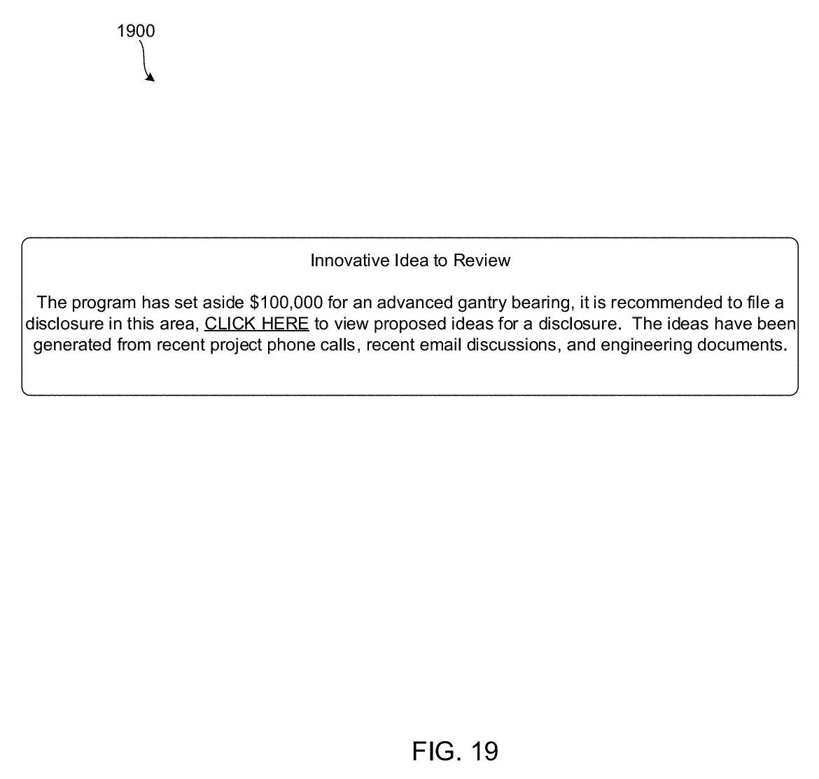

FIG. 19 shows a user interface notification 1900, according to an embodiment. The innovation insights engine has received a trigger of a project funding threshold being met. Thus, it notifies a user of the system to review innovation related to the project. This is one way the system identifies high priority ideas. If an organization pays a certain amount of money, the trigger threshold, related to an individual project or idea, the system automatically displays any related innovation. In the example of FIG. 19, a program has had a budget set for one hundred thousand dollars. Thus, the system identifies the program as high priority because it has met a funding or budgetary threshold, discussed further in relation to FIG. 10. An innovation database is created and all innovation is tracked, with regular user interface notifications to the users, such as shown in FIG. 19. FIG. 19 also displays information as to how the innovation idea was determined, including the data source types used in collecting the innovation information. FIG. 19 refers to the fact that the potential innovation ideas have been generated from recent project phone calls, recent email discussions, and engineering documents.

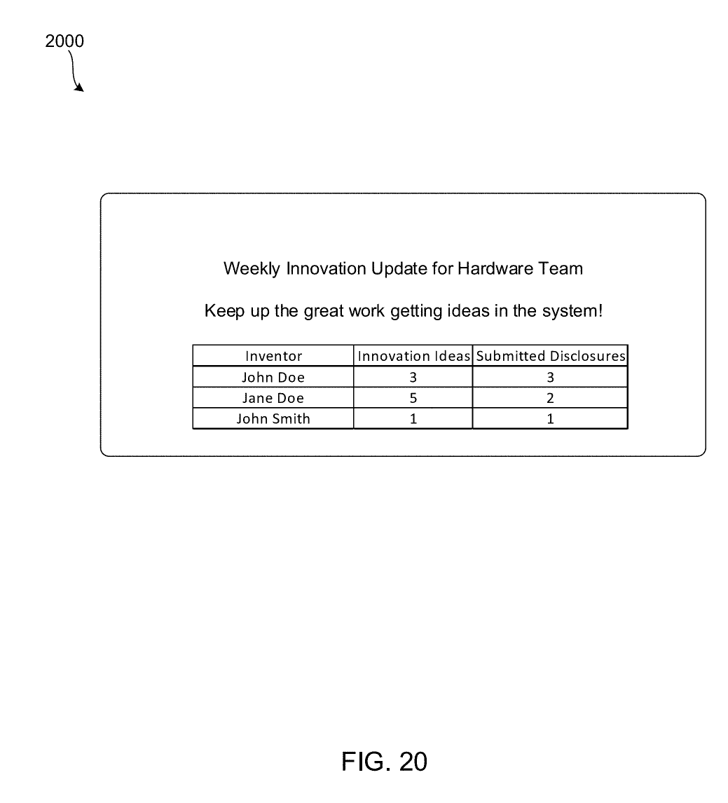

FIG. 20 shows an innovation report 2000 generated by the innovation insights engine, according to an embodiment. The innovation report may be output on paper, a computer screen, or output to a remote network. The innovation report shown in FIG. 20 helps track innovation ideas and promote innovation culture. The innovation report is shown in a scoreboard style, ranking certain individuals based on their innovation ideas. Further, the report identifies areas where additional innovation needs to be captured. For example, Inventor Jane Doe is in second place in the rankings because she only has two innovation ideas submitted for intellectual property review. But the report shows in the first column that inventor Jane Doe has a total of five innovation ideas that could be submitted. This reminds the inventor that she can go into the system, review pre-populated disclosures related to her other innovation ideas, and submit them for intellectual property review. This would put her total up higher on submitted disclosures, moving her up the competition rankings. Such rankings may be helpful in certain organizations to help innovation culture and capture. The innovation report of FIG. 20 is shown as a weekly report for a certain team. The innovation report of FIG. 20 also includes encouraging language to also promote innovation culture in the team.

The benefits of the innovation systems and methods herein, as shown in FIG. 20, are that the innovation report is prepared without additional work from the team. The system captures the related innovation information based on the normal work activities throughout the week. The system captures the related innovation information from all of the data storage sources in relation to FIG. 4 and FIG. 5.

FIG. 20 is only one innovation report example. Other reports can be designed in the system for specific users and needs. For example, management dashboards can be prepared by the innovation insights engine. Management dashboards are interactive user interfaces showing graphs and reporting on innovation across the organization. A real time interactive user interface management dashboard can be helpful to leaders trying to understand activities and drive innovation in their organization. The systems and methods herein improve innovation tracking.

INTRODUCTION TO INSIGHTS

As shown in relation to FIG. 4, the innovation insights engine can provide a plurality of additional innovation insights to users of the system, above and beyond the ability to identify specific innovation ideas and pre-populate innovation disclosures. The innovation insights help guide user action in identifying and protecting innovation. Innovation insights can relate to patents and patent filings, trade secret protection through confidentiality recommendations, trademark filings, copyright filings and labeling, and business-related insights.

PATENT FILING RELATED INSIGHTS

Many organizations have different databases that may include innovation information, but no innovation collection engine to pull the various information and find connections. This can include patent databases within an organization for freedom to operate, innovation submission, pending patent prosecution tracking database, granted patent tracking, competitor tracking, licensing deals and agreements, and intellectual property committee decision tracking. Pulling in all related information to an idea is important to provide full innovation context to users.

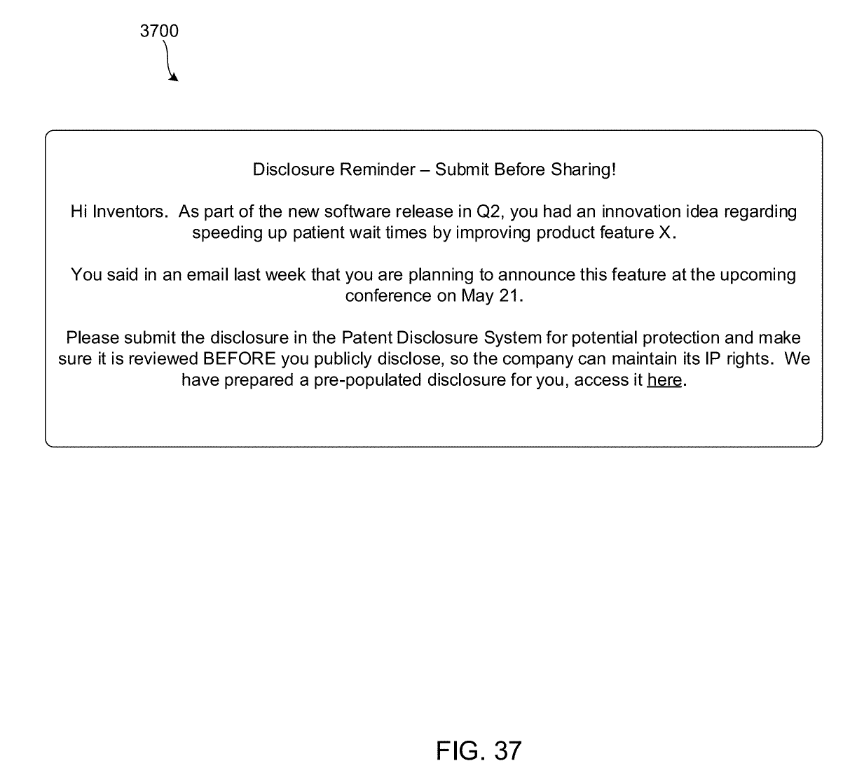

One patent related insight the system can provide is related to legal bar dates. These are dates related to novelty and generally relate to when a product has been sold or when an idea has been shared publicly. When such an event happens, the system can detect it from related deal emails, conference papers, marketing information, and other communication types. A trigger then activates the innovation insights engine to identify and mark the idea as a legal bar trigger date. A clock or timer then starts running as to when a certain innovation protection action must be taken, such as the submission of a patent application. The innovation insights engine can present users with reminders to submit innovation ideas for protection before bar dates occur to preserve legal rights in the innovation. For example, the innovation collection engine comes across an email that states a certain idea will be presented at a customer conference in two months. The innovation collection engine marks the email content as related to potential innovation and assigns it to an innovation database related to the idea. The innovation insights engine is triggered by the keywords of “presented” “customer” as related to a potential public disclosure of the idea and triggers an innovation user interface screen notifying users of the upcoming bar date and the need to protect the innovation. The innovation insights engine also presents a pre-populated disclosure of the idea for review, edit, and submission. FIG. 37 shows an example innovation insight 3700 related to protecting innovation with legal intellectual property protection before it is disclosed publicly and setting a bar date. The innovation insights engine sees that a feature will be announced soon and requests that the inventors review and submit the pre-populated disclosure immediately so that the proper protection can be set in place before public disclosure.

One patent related insight the system can provide is related to cross-organization collaboration, joint innovation, and background intellectual property. Background intellectual property may also be referred to as pre-existing intellectual property. The innovation collection engine can detect legal contracts, legal contract drafts, and legal discussions. It can do so from legal databases, email bodies, email attachments, meeting minutes and telephone calls. The innovation collection engine can assign such discussions to an innovation database related to the collaboration partner. The innovation insights engine detects a proposed date for signing any related agreement that sets off a trigger in the innovation insights engine. The innovation insights engine then can alert the users inside the organization related to the deal that any organization innovation should be submitted and filed before the signature date of the agreement or before any collaboration activity occurs. This benefits the organization by allowing for background intellectual property to be protected and clearly delineated before cross-organization collaboration or joint innovation activity occurs.

One patent related insight the system can provide is to identify inventors. This can take the form of identifying joint inventors on a single idea or proposing to add additional inventors and their ideas into the discussion. As an example for identifying joint inventors, one inventor may have part of the idea in a schematic drawing and another inventor communicates another part of the idea in an email, the system can collect both ideas into the innovation collection engine, identify them as related, and assign them to the same innovation database. Then, when a pre-populated disclosure is generated, the innovation insights engine puts both inventors as inventors. This can help capture all the inventors on an innovation idea.

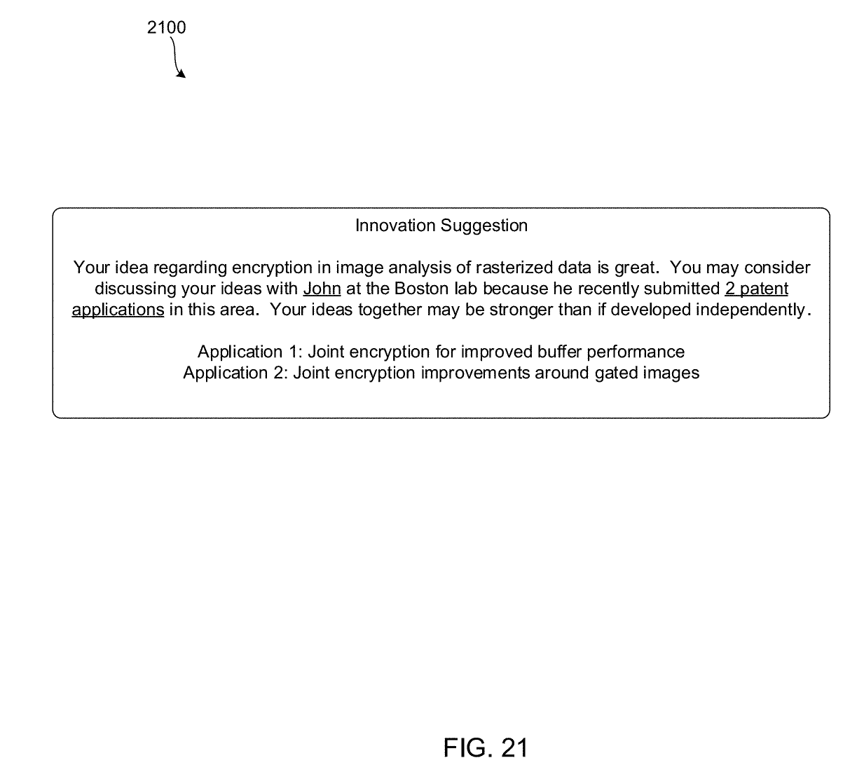

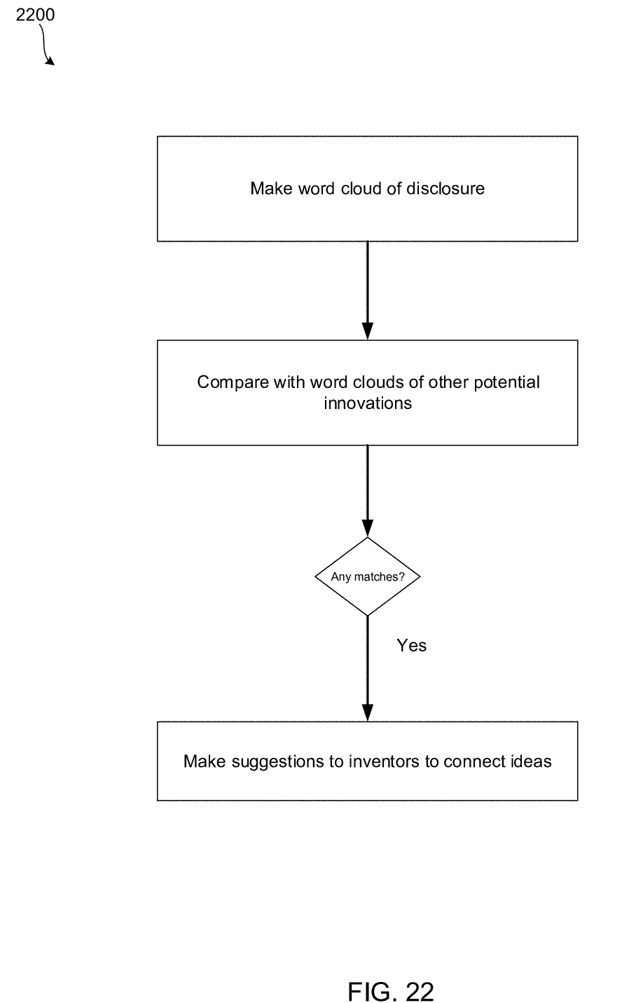

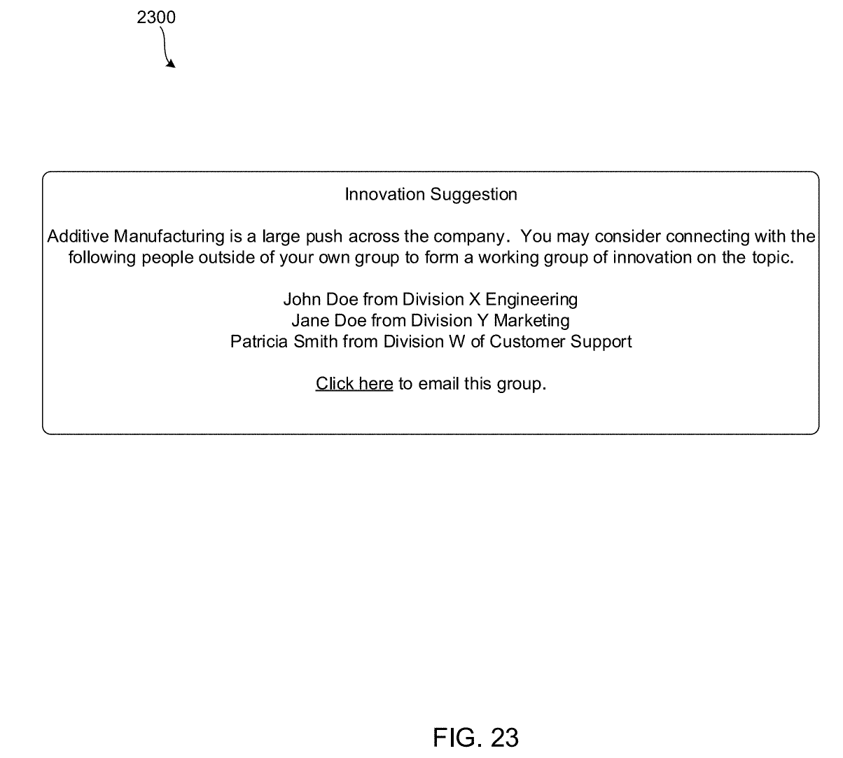

One patent related insight the system can provide is identifying additional inventors in a technical area for collaboration to occur. FIG. 21 shows an innovation connection suggestion user interface, according to an embodiment. FIG. 22 shows a process of identifying related inventors, according to an embodiment. FIG. 23 shows an innovation connection suggestion user interface.

FIG. 21 shows a user interface 2100 where two individuals who were not collaborating previously are recommended to collaborate because they are working in similar technology areas. For the example of FIG. 21, two branches of a government are working on joint encryption technologies. The system collects in the information of both branches of government, sees related innovation areas, assigns them to the same innovation database, and the innovation insights engine recommends a connection between the two individuals, as shown.

FIG. 22 a process 2200, in an embodiment, for identifying related inventors. First, a word cloud of an innovation disclosure is made. This can be a pre-populated disclosure from the innovation insights engine or a disclosure finished and submitted to the intellectual property committee. Then the innovation insights engine compares that word cloud with the data stored in the innovation data store about other potential innovation ideas. If matches are found, the innovation insights engine generates an insight to present to the users, such as shown in FIG. 21 and FIG. 23. Matches are generally based on related technology areas found in the technical problem and technical solution areas of the ideas. Patent related databases are a good source of this type of material for inventor matching. Matches may also be found within human resources organization charts that list the titles and skillsets of individuals. For the example of FIG. 21, the system can match up individuals who have an organization title or specialty of “joint encryption specialist.”

FIG. 23 shows a user interface notification 2300 with an innovation suggestion. The suggestion is to connect multiple people across a large organization together to create an innovation working group. This working group may include people in deferent divisions, departments, and job functions. In the example of FIG. 23, the innovation insights engine suggests to connect individuals across engineering, marketing, and customer support in order to join together to innovate.

One patent related insight the system can provide is prior art identification. This means identifying relevant, previous technologies to an innovation idea. As discussed above, the innovation collection engine can pull information in from internal patent databases and product databases relating to the organizations own prior public technologies. And the innovation collection engine can pull information in from public and paid databases that include: individuals and their job titles, such as LinkedIn™; public patent prior art, such as Google™ patents; technical prior art journals and publications, such as IEEE™; and more. Such prior art understanding can help decision making within the organization, around innovation protection and competitive decision-making.

Helping innovators understand what is in their entity's intellectual property portfolio is a benefit for this system. The system can alert the individual to related innovation, patent filings, and individuals to help create connections and improve the quality of innovator understandings.

An approach to prior art searching is currently performed using patent search tools where the innovator enters, or the system automatically generates, keywords to describe the invention and search for patents and patent applications that contain those keywords. The resulting patent search result sets can be very large and overwhelm the individual with too much data and many search results that are not applicable to the specific application being searched. For example, a search for medical ultrasound using the keyword “ultrasound” will yield search results that include medical ultrasound devices and non-medical applications such as ultrasound welding. These limitations can be overcome with experience, but for the inventor who may only perform a patent search once a year, may not be familiar with search techniques, or method to quickly review a large set of patents.

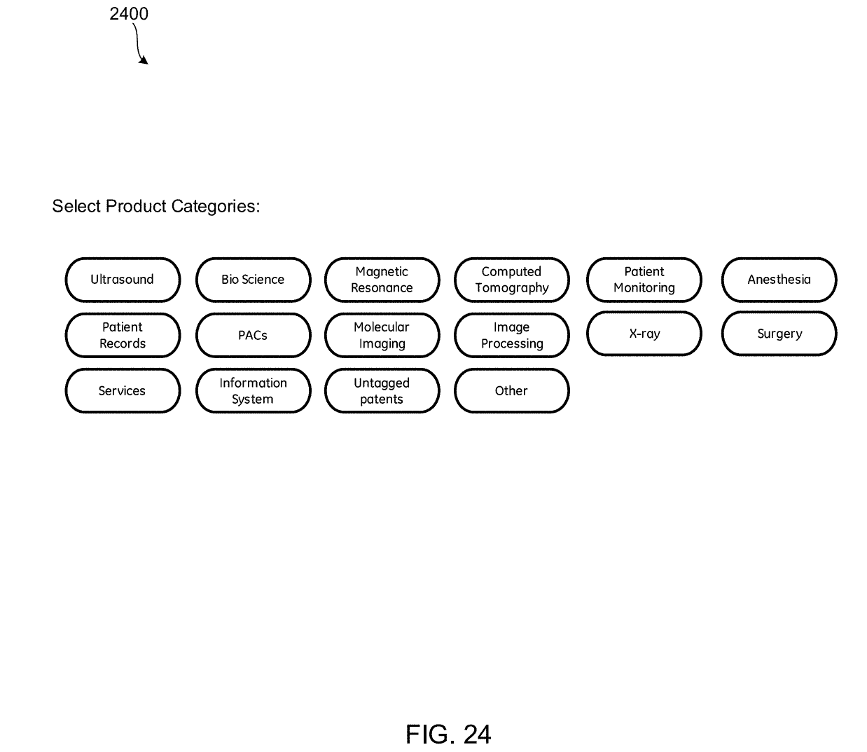

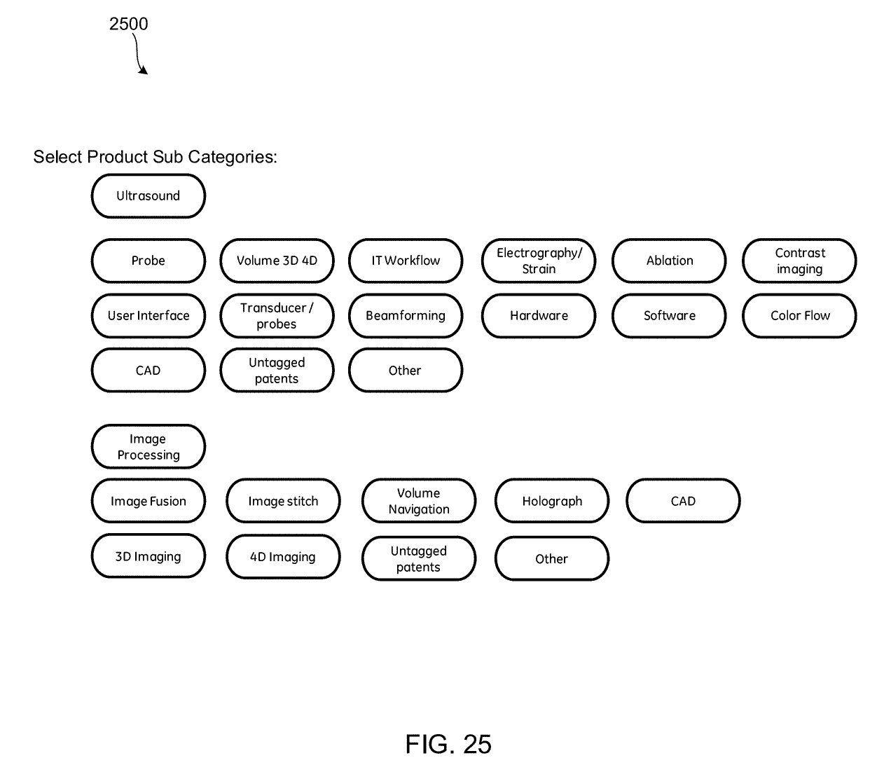

To streamline the process the innovation insights engine allows an inventor to search through patents using a graphical interface and search aids to find the most applicable prior art. This system utilizes automated patent classification to group patents by product area (e.g. ultrasound, x-ray, magnetic resonance, electronic medical records, image information systems etc.) and by sub- categories applicable to a particular product area. For example, sub-categories of ultrasound may contain probes, user interface, software, ablation, beamforming and other concepts commonly related to use of medical ultrasound. FIG. 24 and FIG. 25 show graphical interface 2400 and graphical interface 2500 and selects the product area(s) and sub-categories of interest, respectively. This allows them to limit the patent result set to those associated with the product area(s) and sub-category(s) that are of interest.

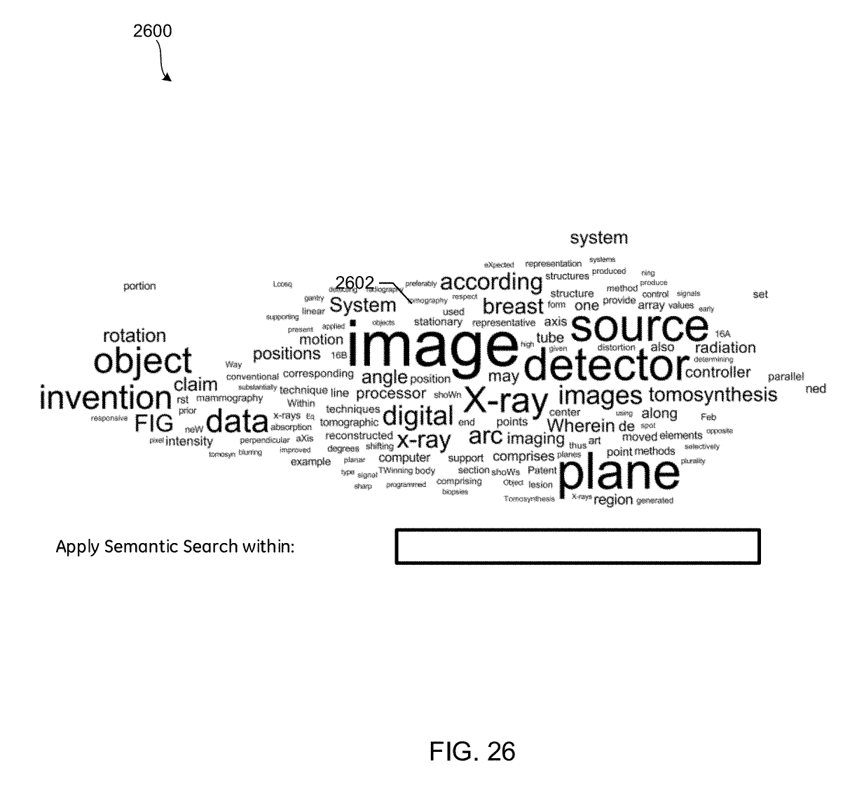

FIG. 26 shows user interface 2600 providing additional ways of helping innovators find related prior art. Once a user or the innovation insights engine has identified the sub-categories of interest, there is still often a very large number of patents requiring review. The innovation insights engine aids in the identification of applicable prior art, by providing tools that can further summarize the patent set. In one embodiment, a word cloud 2602 is shown, allowing the user to select topics that the result set contains. The user can then select terms or phrases that are applicable to the invention and view the patents containing those terms or phrases. This process allows the user to view and select a variety of key terminology and phrases found in the result set that may describe the patent subject matter by using different terminology, or patent legal-speak than the user anticipated. This is especially helpful for an inventor that may be working in a second language. These user interfaces help innovators narrow down the areas for prior art search and help the system build better innovation databases.

Filters can also be added to limit patent result sets by other factors. These factors may include patent expiration status, assignee name, inventor name, or further key words desired by the Inventor. The final result set may be reviewed using an interface where the search marks which patents are to be included as known prior art for incorporation for submission to a patent office.

PATENT LANDSCAPE RELATED INSIGHTS

One patent related insight the system can provide is the identification of white space. White space are open areas where a lower percentage of patent filings and technology innovation has occurred. White space areas can be automatically determined by the innovation insights engine reviewing the innovation data store and the results from the innovation collection engine. White space areas can also be identified as loaded into the system by previous human endeavor.

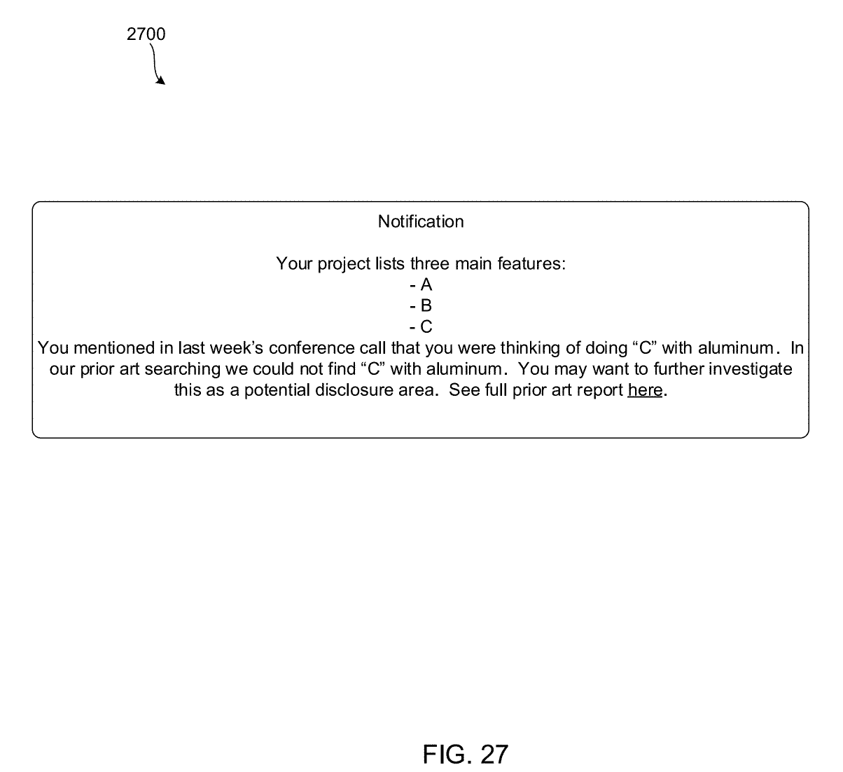

FIG. 27 shows a user interface notification 2700 related to white space, according to an embodiment. The innovation insights engine may review the innovation data store for a particular project. In preparing the pre-populated innovation disclosures for the three main technological improvements of the project (A, B, and C in FIG. 27), the system notices that no prior art can be found for idea C. The innovation insights engine then generates and provides the innovation insight as shown in FIG. 27. The innovation insight alerts the user to white space, encourages further investigation, and provides a link to the related prior art search information for review.

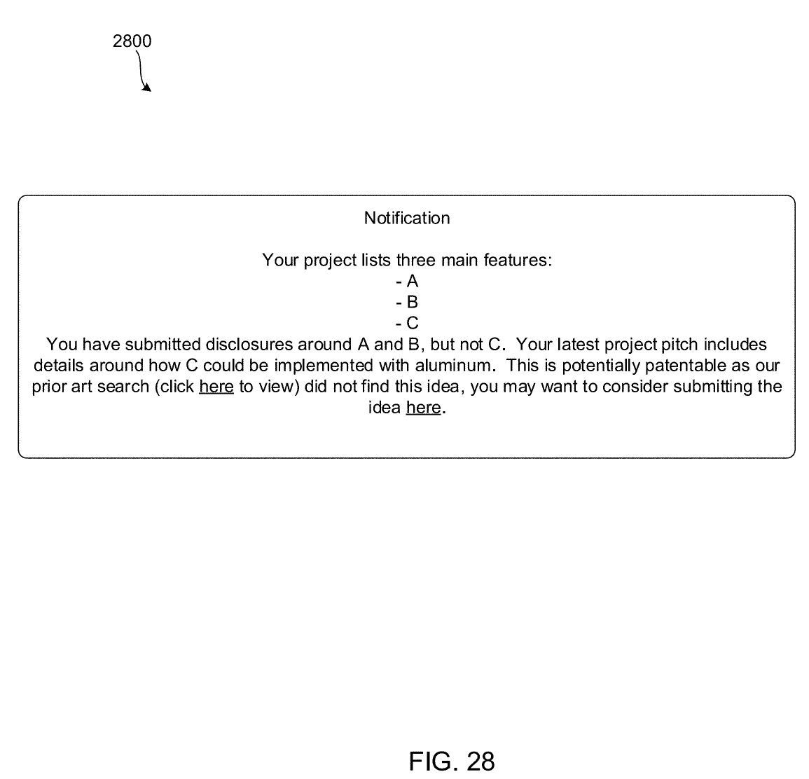

FIG. 28 shows a user interface notification 2800 related to innovation ideas that are located in a white space. In this example, the inventor has submitted two disclosures for ideas A and B. The innovation insights engine notes that a new idea, idea C, has been added as part of a recent pitch file, or presentation file. The innovation insights engine generates the innovation insight notification shown in FIG. 28. The notification identifies that idea C is related to a relatively open area of technology. The notification recommends submission of a disclosure related to idea C, and provides links to the prior art search and to where the user can view a pre-populated disclosure for edit and submission.

In addition, market related innovation ideas are tracked. These include problems that customers identify in goods and services. These include solutions that competitors are marketing and promoting. White space and technology areas for investigation are identified through the tracking of these market related innovation ideas.

One patent related insight the system can provide is around patent portfolio building. Similar ideas can be identified by the innovation collection engine or the innovation insights engine. Alerts can then be provided for tagging various innovation ideas as part of a portfolio.

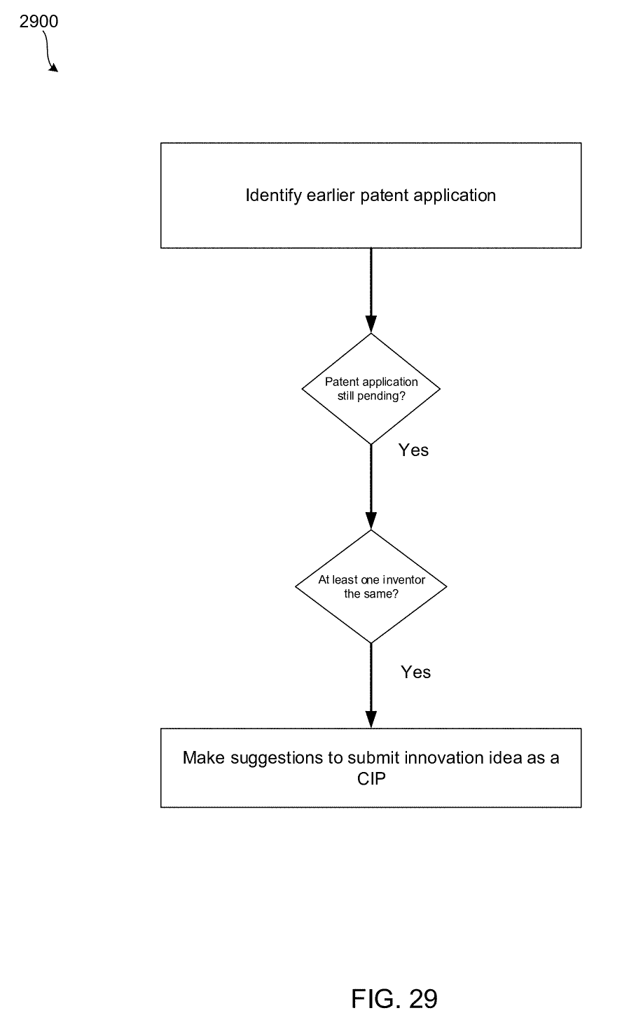

FIG. 29 shows a process 2900 for patent portfolio building, according to an embodiment. The innovation collection engine pulls information from a patent database that includes the organization's pending patent applications. It associates certain granted patents and pending applications with a portfolio or innovation database. If a pre-populated disclosure is generated by the innovation insights engine related to the same portfolio, the innovation insights engine checks if there are any pending patent applications pending in the portfolio. If so, the innovation insights engine checks if there is at least one same inventor between the pending patent application and the new innovation idea. If so, the innovation insights engine may generate an innovation insight to file the new innovation idea as a continuation-in-part (CIP) patent application from the pending application. If not, the innovation insights engine may generate an innovation insight to see if one of the inventors from the previous pending patent application should be considered as an inventor on the current innovation idea.

One patent related insight the system can provide is alerts of external innovation activity. The system and methods herein have access to external sources of information and can use such information to inform an organization on external innovation activity.

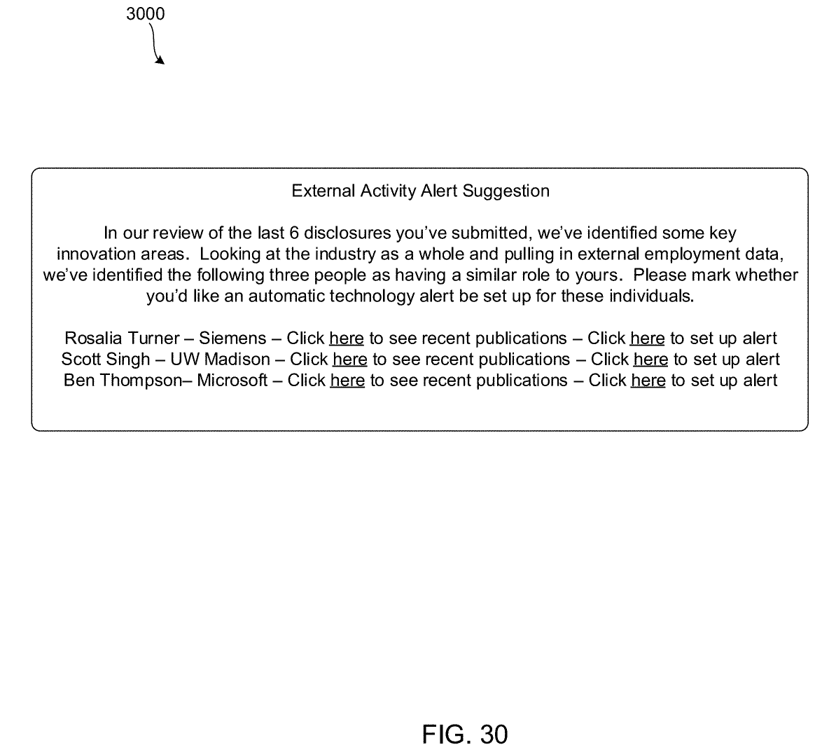

FIG. 30 shows an innovation insight notification 3000 related to an external activity alert notification. The innovation collection engine has pulled in information from external sources and assigned the potential innovation to an innovation database around a certain role. This may be Chief Scientist for balloon technologies, for example. No matter who has the role over time, the related innovation database continues to build up information helpful for innovations in that role. Such helpful information may include public innovations from external parties and the individuals who generated such public innovations.

The innovation insight shown in FIG. 30 provides information on three types of activities performed by the innovation insights engine to give benefit to the user. First, the innovation insight provides automatic analysis and information related to others in the industry who may have a similar role as the user. Second, the innovation insight provides a link or button to related publications and technological information related to the other individual's innovation. This can have tremendous value to an innovator. Third, the innovation insight provides a button or link that allows the user to set up an innovation alert related to the individual. This alert could be an alert related to patents filed or granted, related to papers that are published, related to updates in their employment status, or related to conferences or public talks the individual may be giving. All of these types of alerts provide benefit to the user of the innovation systems and methods disclosed herein. In highly specialized fields, a lot can be learned just by following the activity of a few individuals. If the user selects to create any of these types of alerts, such alert systems can be within the innovation insights engine or using third party tools depending on the nature of the alert. FIG. 30 can also show pictures and short biographies of each individual pulled from public and subscription databases.

One patent related insight the system can provide is when innovations should be filed, according to an embodiment. The innovation insights engine sees information related to the patent budget. Innovation insight triggers can thus be set when a budget cycle is ending and the budget is either too low by a certain amount or too high by a certain amount. For example, if the budget was too low by a certain amount, the innovation insights engine can run a report of innovation ideas and proposed some pre-populated disclosures to approve for patent filing. For example, if the budget was too high by a certain amount, the innovation insights can recommend some pre-populated disclosures for defensive publication instead of patenting if the prior art space is more of a patent thicket than a white space. Through such means and other related innovation insights, the innovation insights engine can help an organization better manage its patent budget.

MONETIZATION AND UTILIZATION RELATED INSIGHTS

The innovation insights engine also provides insights for later in the life cycle of an innovation idea. Once an innovation idea becomes a granted patent, the innovation insights engine can look for ways to utilize and monetize the idea. For example, if prior art searching finds a competitor document that includes claimed subject matter of one of the organizations' granted patents, an innovation insight can be generated related to the potential licensing opportunity. Further, because the system has access to the legal contracts of the organization, the innovation insights engine can analyze past agreements to understand which patents have been in-licensed and out-licensed, for how much, and with whom. Thus, the system can generate an innovation data store solely around licensing data internal to the organization. Additional licensing information from market news and public databases such as legal court proceedings may give additional information for the innovation database around licensing data.

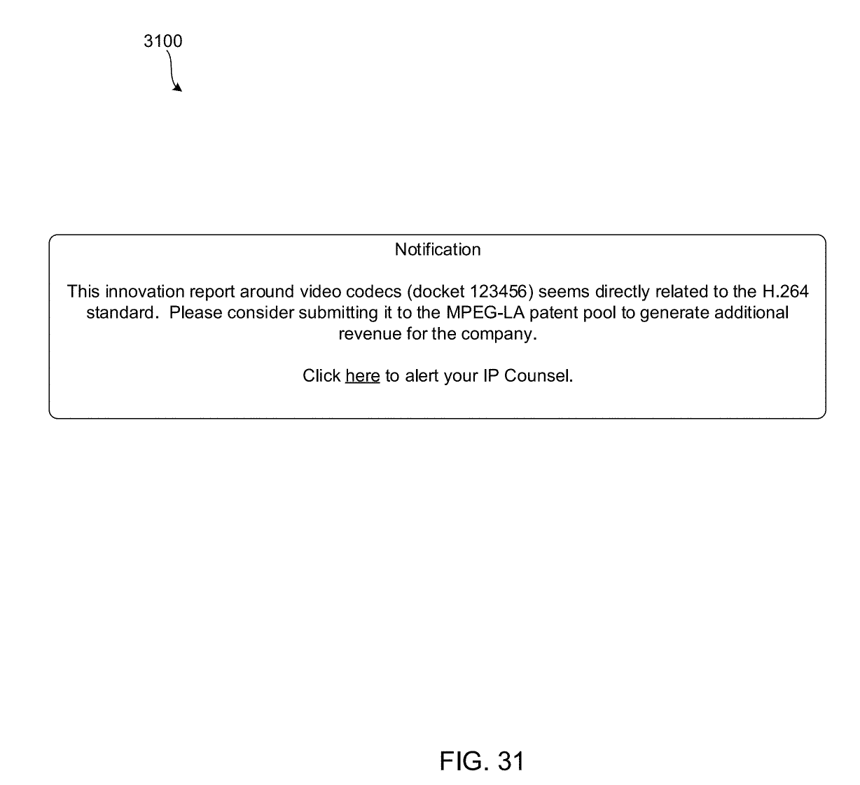

FIG. 31 provides an exemplary innovation insight 3100 related to patent pool licensing. Patent pool information can be automatically retrieved from external sources or pre-loaded by an individual supporting the innovation system. An insight is generated that provides notice to a user that a current innovation idea within an innovation report seems related to a specific patent pool. The insight further recommends a specific action of submitting the idea to the patent pool and gives the user a link or button to contact their intellectual property counsel for support. If the user clicks the link or button, the innovation insights engine can generate an email or other alert to the intellectual property counsel for the organization.

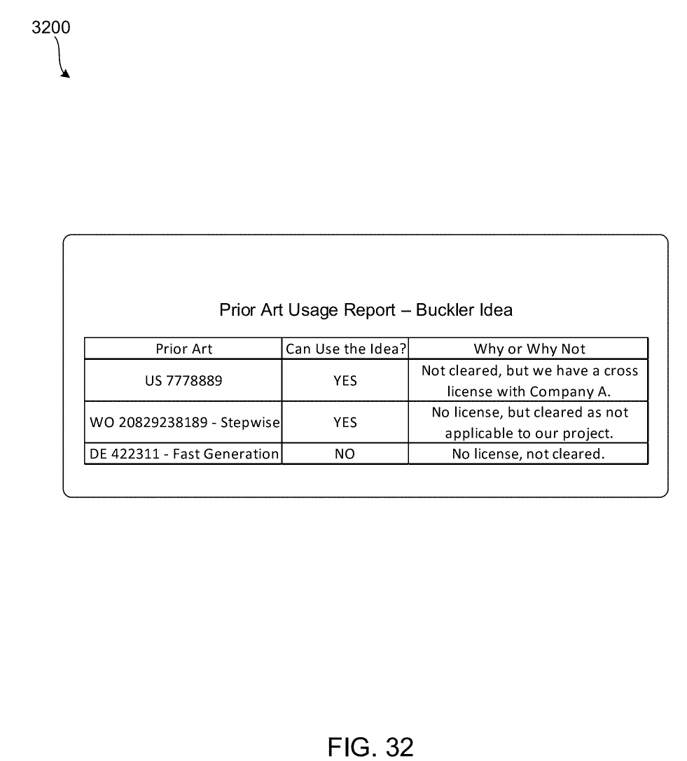

Once the system understands the current licensing deals of the organization, the innovation insights engine can provide a report of whether or not the organization can utilize ideas certain patents. This type of review and innovation alert helps give organizations freedom to operate. FIG. 32 provides an exemplary innovation insight 3200 giving feedback to the users of an organization on whether they can use certain ideas that may be patented. The innovation insights engine has a process to determine whether a given patent is cleared for use. It considers whether the patent covers the territory of the proposed activity; whether the patent is expired or in force; whether the organization has a license to use the patent through direct license, cross license, patent pool, or other agreement; and whether an individual at the organization has previously reviewed the patent and given clearance to proceed. FIG. 32 lists three patents related to an innovation idea, gives clear indication whether the team can use the patented idea, and an explanation of why the innovation insights engine gave the indication. This clarity can help business and engineering teams as they decide on features and implementations to bring to market.

STANDARDS RELATED INSIGHTS

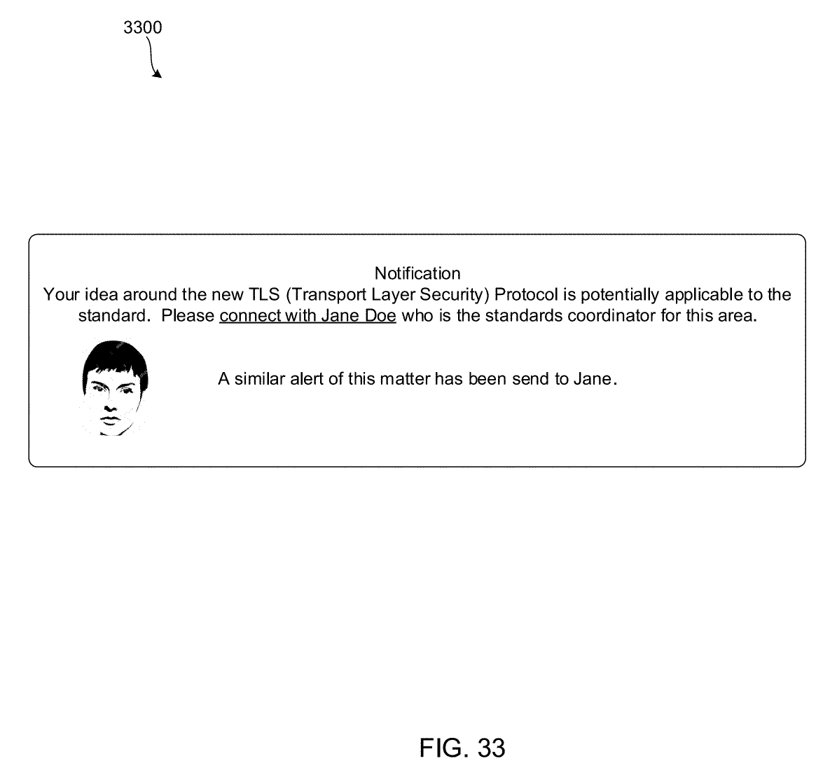

FIG. 33 shows an innovation insight alert 3300 related to industry standards, according to an embodiment. Standards information can be automatically retrieved from external sources or pre-loaded by an individual supporting the innovation system. In the example of FIG. 33, the innovation insights engine was pre-populating a disclosure and notice that an idea is related to an industry standard. In addition to filling out the related field, as shown in FIG. 14, the innovation insights engine also generates an innovation insight alert 3300. Since the innovation insights engine can receive information from the human resources data storage system, it can provide the email address and picture for the individual in the organization who supports the related industry standard.

CONFIDENTIALITY AND TRADE SECRET INSIGHTS

Protecting trade secret information is vital to any organization. The innovation systems and methods herein disclosed help identify trade secrets for protection. Technological trade secrets are usually innovative, so they are identified through the innovation identification systems and methods herein. The innovation insights engine then reviews the innovation and can recommend trade secret designation, labeling, and protection for certain areas of innovation.

The innovation insights engine may have a specific module or processing engine for trade secret recommendation generation. Based on the information related to the idea, the innovation insights engine uses a neural network deep learning algorithm to identify potential trade secrets. Nodes within the neural network can be associated with criteria considered. Feedback as to what was rated and kept as trade secret in previous intellectual property committee meetings is important to the continual improvement of trade secret recommendation generation.

A first trade secret criterion is the inventor. Certain inventors may trend towards trade secret based on the technology they work on. Further, the system knows what the inventor's previous innovation disclosures have been rated by the intellectual property committee. If an inventor's innovation disclosures are consistently rated as trade secret, the probability of future innovation ideas been rated as a trade secret is higher.

A second trade secret criterion is the technology type. Certain technologies, such as algorithms and manufacturing processes, are more commonly kept as trade secret than other types of technologies. Based on the technological problem and solution identified in a pre-populated disclosure, the system can more highly rate something as a potential trade secret.

A third trade secret criteria are keywords communicated by individuals. If the system detects phrase such as “highly confidential”, “top secret”, or “trade secret” being communicated by individuals referring to the innovation idea, the system can more highly rate something as having trade secret potential.

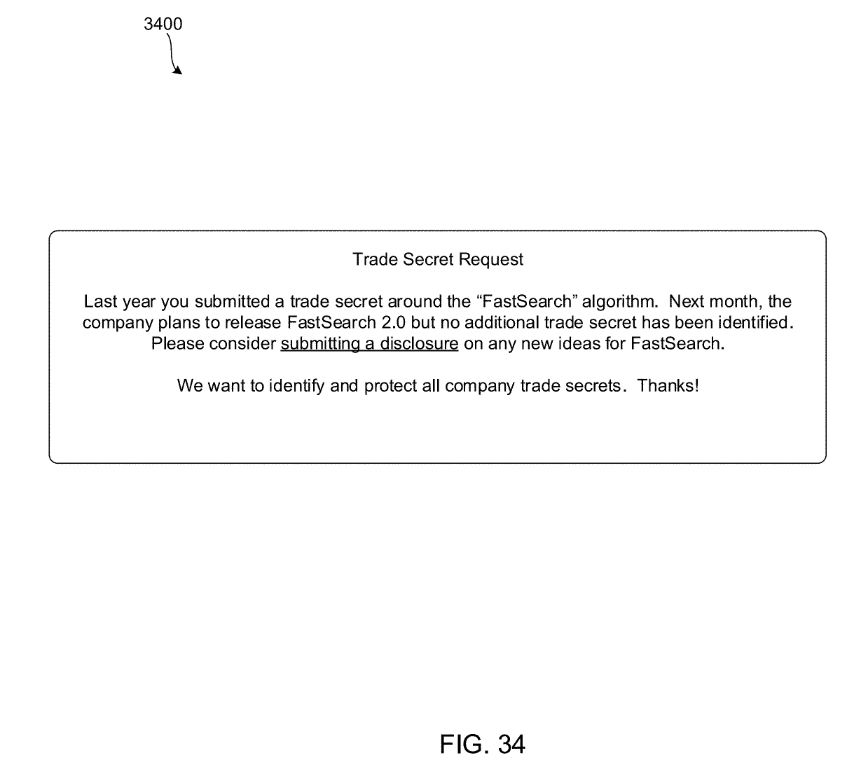

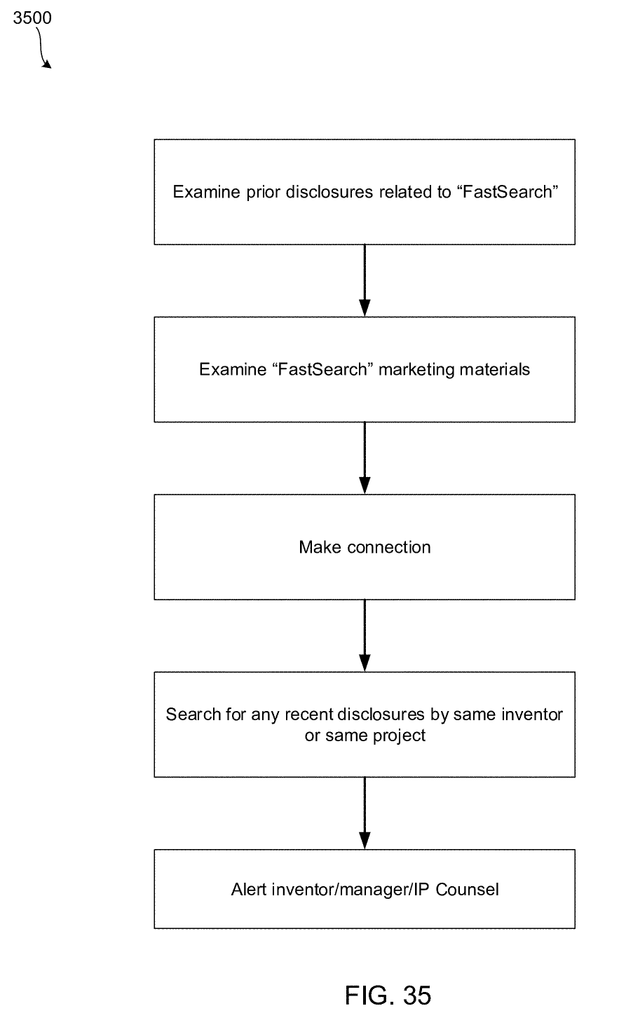

A fourth trade secret criterion is the history of related cases. FIG. 34 and FIG. 35 describe show such an example. A certain feature of the product called FastSearch. The innovation insights engine pre-populates an innovation disclosure. The first step of the process 3500 in FIG. 35 reviews the “feature” field of the pre-populated innovation disclosure and sees the feature called FastSearch. Then the process analyzes previous innovation disclosures for the related feature name and any decisions made on any related disclosures. In this example, the system finds a related disclosure that was rated as a trade secret the previous year. In the next step, the innovation insights engine captures the FastSearch keyword as mentioned in marketing material for release in a month. The innovation insights engine looks to find related disclosures and finds both the current and previous innovation disclosures. Then an innovation insight 3400 is generated based on the totality of information, such as the one shown in FIG. 34. FIG. 34 shows an innovation insight 3400 that notifies the manager, inventor, or other user in the system of the disclosure potential. The innovation insight informs the user that a previous disclosure was rated as trade secret, the news about the FastSearch product release in a month, and a request to review and submit any new innovation disclosures. In addition, the innovation insight includes a knowledge tip in an encouraging fashion to help promote innovation protection and innovation culture. If a user clicks on the link shown in the alert, it will bring them to the pre-populated disclosure for their review, editing, and approval.

A fifth trade secret criterion is documentation marking. If a document is specifically marked as highly confidential or as a trade secret, the innovation insights engine may rank a trade secret recommendation higher than otherwise. Additional trade secret criteria may be used in the innovation insights engine. Examples described are illustrative of some, but not all, of the potential nodes for trade secret recommendation generation.

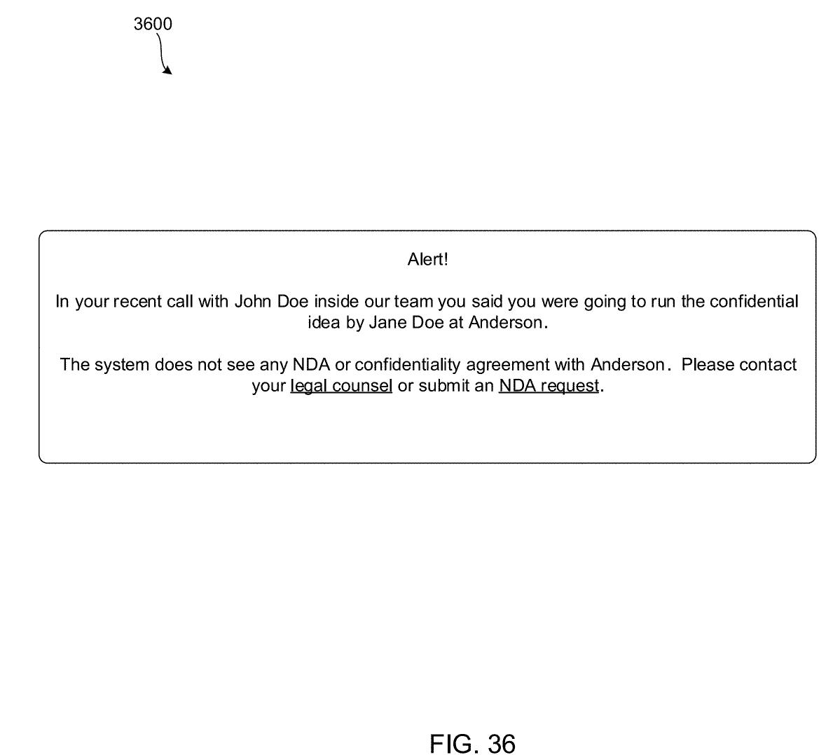

FIG. 36 shows an innovation insight 3600 related to trade secret protection, according to an embodiment. In this example of an innovation insight generated by the innovation insights engine, a phone call is recorded and the transcript is searched. An idea that has been previously rated as a trade secret by the intellectual property committee is the subject of the call. The innovation insights engine 404 notes from the transcript that the idea may be shared with an outside party. The innovation insights engine 404 then checks the legal database to see if a legal agreement with confidentiality provisions is in place with the outside party. Since there is not, the innovation insights engine 404 generates the insight 3600 and provides it to the user, as shown in FIG. 36. In the insight, the user can click to see the idea and the fact it is rated trade secret. The user can also click to be connected with their legal counsel or an online form to fill out to request a non-disclosure agreement (“NDA”). Through insights like the one shown in FIG. 36, the innovation systems and methods disclosure herein help protect organizations from information leakage and trade secret misuse.

BUSINESS RELATED INSIGHTS

One type of innovation insight is partner suggestion information. Not all market data and prior art about innovation in similar areas is about competitors. If a company is developing a part and so is another company, sometimes they may decide to work together or one company may end up supplying the other company with the part. Thus, the through identification of similar technological activity through prior art searching and competitive information gathering, the innovation insights engine 404 may suggest contacting another entity for potential partnership or collaboration discussions.

One type of innovation insights is an intelligent meeting summary. At meetings had a meeting, the system can detect from the calendar database what the title and agenda are for the meeting, as well as the participants. The system knows what each participant sounds like from previous audio learning. The system also can also record and capture anything shared over online screen sharing or emailed between the participants during the meeting. Then the system can create an intelligent meeting parsing. It can parse the audio and create a transcript, including the names of each speaker and highlighting the keywords (such as project name, key technology areas, or action items). The system can also parse the presentation, email, and other shared content as well, creating digital transcripts and groupings of that content. The system can then provide to the users an intelligent meeting summary of the activity, information, and action items from the meeting. This is a great benefit when organizations have many meetings and individuals in the organization have a lot to manage. These types of meeting summaries, being automatically prepared, can save time and help information be saved for future use.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

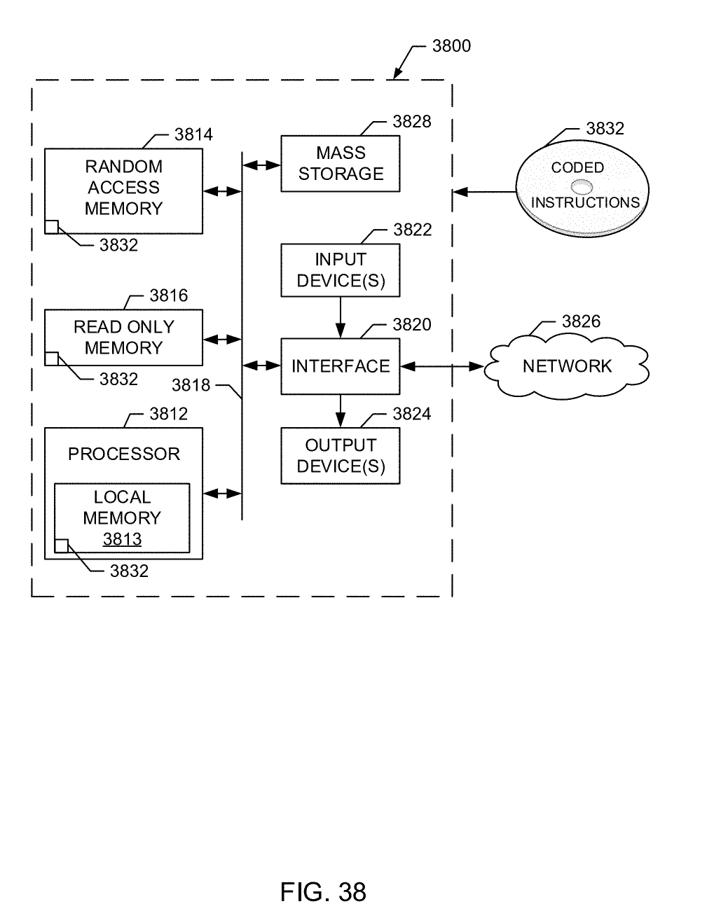

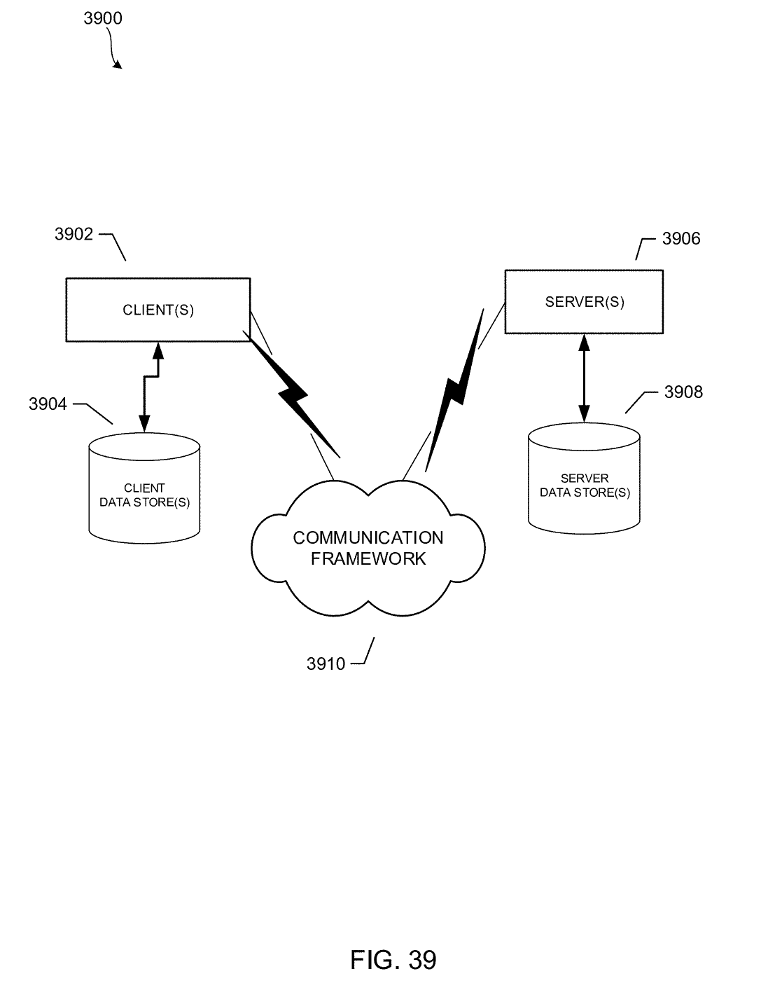

In order to provide a context for the various aspects of the disclosed subject matter, FIGS. 38 and 39 as well as the following discussion are intended to provide a brief, general description of a suitable environment in which the various aspects of the disclosed subject matter may be implemented.

FIG. 38 is a block diagram of an example processor platform 3800 capable of executing the instructions of FIG. 4 to implement the example innovation insights engine. The processor platform 3800 can be, for example, a server, a personal computer, a mobile device (e.g., a cell phone, a smart phone, a tablet), a personal digital assistant (PDA), an Internet appliance, or any other type of computing device.

The processor platform 3800 of the illustrated example includes a processor 3812. Processor 3812 of the illustrated example is hardware. For example, processor 3812 can be implemented by one or more integrated circuits, logic circuits, microprocessors or controllers from any desired family or manufacturer.

Processor 3812 of the illustrated example includes a local memory 3813 (e.g., a cache). Processor 3812 of the illustrated example is in communication with a main memory including a volatile memory 3814 and a non-volatile memory 3816 via a bus 3818. Volatile memory 614 can be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 616 can be implemented by flash memory and/or any other desired type of memory device. Access to main memory 3814, 3816 is controlled by a memory controller.

Processor platform 3800 of the illustrated example also includes an interface circuit 3820. Interface circuit 3820 can be implemented by any type of interface standard, such as an Ethernet interface, a universal serial bus (USB), and/or a PCI express interface.

In the illustrated example, one or more input devices 3822 are connected to the interface circuit 3820. Input device(s) 3822 permit(s) a user to enter data and commands into processor 3812. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 3824 are also connected to interface circuit 3820 of the illustrated example. Output devices 3824 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). Interface circuit 3820 of the illustrated example, thus, typically includes a graphics driver card, a graphics driver chip or a graphics driver processor.

Interface circuit 3820 of the illustrated example also includes a communication device such as a transmitter, a receiver, a transceiver, a modem and/or network interface card to facilitate exchange of data with external machines (e.g., computing devices of any kind) via a network 3826 (e.g., an Ethernet connection, a digital subscriber line (DSL), a telephone line, coaxial cable, a cellular telephone system, etc.).

Processor platform 3800 of the illustrated example also includes one or more mass storage devices 3828 for storing software and/or data. Examples of such mass storage devices 3828 include floppy disk drives, hard drive disks, compact disk drives, Blu-ray disk drives, RAID systems, and digital versatile disk (DVD) drives.

Coded instructions 3832 of FIG. 4 can be stored in mass storage device 3828, in volatile memory 3814, in the non-volatile memory 3816, and/or on a removable tangible computer readable storage medium such as a CD or DVD.

FIG. 39 is a schematic block diagram of a sample-computing environment 3900 with which the subject matter of this disclosure can interact. The system 3900 includes one or more client(s) 3902. The client(s) 3902 can be hardware and/or software (e.g., threads, processes, computing devices). The system 3900 also includes one or more server(s) 3906. Thus, system 3900 can correspond to a two-tier client server model or a multi-tier model (e.g., client, middle tier server, data server), amongst other models. The server(s) 3906 can also be hardware and/or software (e.g., threads, processes, computing devices). The servers 3906 can house threads to perform transformations by employing this disclosure, for example. One possible communication between a client 3902 and a server 3906 may be in the form of a data packet transmitted between two or more computer processes.

The system 3900 includes a communication framework 3910 that can be employed to facilitate communications between the client(s) 3902 and the server(s) 3906. The client(s) 3902 are operatively connected to one or more client data store(s) 3904 that can be employed to store information local to the client(s) 3902. Similarly, the server(s) 3906 are operatively connected to one or more server data store(s) 3908 that can be employed to store information local to the servers 3906.

It is to be noted that aspects or features of this disclosure can be exploited in substantially any wireless telecommunication or radio technology, e.g., Wi-Fi; Bluetooth; Worldwide Interoperability for Microwave Access (WiMAX); Enhanced General Packet Radio Service (Enhanced GPRS); Third Generation Partnership Project (3GPP) Long Term Evolution (LTE); Third Generation Partnership Project 2 (3GPP2) Ultra Mobile Broadband (UMB); 3GPP Universal Mobile Telecommunication System (UMTS); High Speed Packet Access (HSPA); High Speed Downlink Packet Access (HSDPA); High Speed Uplink Packet Access (HSUPA); GSM (Global System for Mobile Communications) EDGE (Enhanced Data Rates for GSM Evolution) Radio Access Network (GERAN); UMTS Terrestrial Radio Access Network (UTRAN); LTE Advanced (LTE-A); etc. Additionally, some or all of the aspects described herein can be exploited in legacy telecommunication technologies, e.g., GSM. In addition, mobile as well non-mobile networks (e.g., the Internet, data service network such as internet protocol television (IPTV), etc.) can exploit aspects or features described herein.

While the subject matter has been described above in the general context of computer-executable instructions of a computer program that runs on a computer and/or computers, those skilled in the art will recognize that this disclosure also can or may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone), microprocessor-based or programmable consumer or industrial electronics, and the like. The illustrated aspects may also be practiced in distributed computing environments where tasks are performed by remote processing devices that are linked through a communications network. However, some, if not all aspects of this disclosure can be practiced on stand-alone computers. In a distributed computing environment, program modules may be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

Various aspects or features described herein can be implemented as a method, apparatus, system, or article of manufacture using standard programming or engineering techniques. In addition, various aspects or features disclosed in this disclosure can be realized through program modules that implement at least one or more of the methods disclosed herein, the program modules being stored in a memory and executed by at least a processor. Other combinations of hardware and software or hardware and firmware can enable or implement aspects described herein, including a disclosed method(s). The term “article of manufacture” as used herein can encompass a computer program accessible from any computer-readable device, carrier, or storage media.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

In this disclosure, terms such as “store,” “storage,” “data store,” “data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or methods herein are intended to include, without being limited to including, these and any other suitable types of memory.

It is to be appreciated and understood that components, as described with regard to a particular system or method, can include the same or similar functionality as respective components (e.g., respectively named components or similarly named components) as described with regard to other systems or methods disclosed herein.

What has been described above includes examples of systems and methods that provide advantages of this disclosure. It is, of course, not possible to describe every conceivable combination of components or methods for purposes of describing this disclosure, but one of ordinary skill in the art may recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The systems and methods proposed herein help collect, identify, protect, and gain insights from innovation. The benefits of such a system include, but are not limited to, better intellectual property protection, better budget management, less work for inventors and mangers, better innovation culture, innovation decisions made more quickly and with more information, better trade secret protection, stronger patent filings, higher quality innovation disclosures, more licensing and standardization activity identified, better brainstorm sessions, improved team intellectual property knowledge, and improved team morale.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the invention without departing from their scope. While the dimensions and types of materials described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled.

In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. An innovation capture system, comprising:
a plurality of data storage systems that store general data;
an innovation collection engine that receives general data from the plurality of data storage systems, identifies innovation data from within the general data, and stores the innovation data in one or more innovation data stores; and
an innovation insights engine that analyzes the stored innovation data, retrieves information data relating to a particular innovation idea, and populates an innovation disclosure form based on the information data related to the particular innovation idea.

2. The innovation capture system of claim 1, wherein:
the stored innovation data includes data source information referring to which of the plurality of data storage systems the innovation data originated from;
an innovation disclosure form includes a field indicating the data source information for each information datum; and
the innovation insights engine populates data source information into the related field in the populated innovation disclosure form.

3. The innovation capture system of claim 1, wherein:
identifying innovation includes comparing the general data to innovation criteria.

4. The innovation capture system of claim 3, wherein innovation criteria include one or more of:
a prior art comparison criterion, a direct input criterion, a keyword criterion, an ideation system feedback criterion, an effort criterion, a funding amount criterion, and a felt need criterion.

5. The innovation capture system of claim 3, wherein:
identifying innovation further includes applying a weighting function to the output of each comparison of the general data to innovation criteria; and
identifying the general data as innovation data if the combined weighted outputs from each comparison exceed an innovation threshold.

6. The innovation capture system of claim 1, wherein:
the innovation insight engine comprises a patentability decision engine that receives innovation data and outputs one or more patentability ratings for the innovation data.

7. The innovation capture system of claim 6, wherein:
the patentability decision engine includes a deep learning neural network system.

8. The innovation capture system of claim 6, wherein:
the patent ability ratings comprise one or more of detectability, likelihood of infringement, idea type, economic impact, breadth of idea, difficulty to design around, novelty, and value to organization.

9. The innovation capture system of claim 1, wherein:
the innovation insight engine comprises an intellectual property decision engine that receives innovation data and outputs one or more intellectual property recommendations for the innovation data.

10. The innovation capture system of claim 9, wherein:
the intellectual property recommendations comprise one or more of file utility patent application, file design patent application, file plant patent application, file utility model patent application, defensive publish, protect trade secret, file copyright, consolidate with another idea, improve idea description, or no further consideration.

11. An innovation identification system, comprising:
a plurality of data sources that generate and store general data;
a communication framework;
an innovation collection engine comprising an innovation identification module and an innovation assignment module;
a plurality of innovation data stores;
wherein:
each data source transmits general data through the communication framework to the innovation collection engine;
the innovation identification module determines whether the general data is potential innovation; and
if the general data is potential innovation, the innovation assignment module assigns it to one or more innovation data stores.

12. The innovation identification system of claim 11, wherein:
the innovation identification module performs innovation analysis on the general data to analyze evidence of strength over prior art, direct input of innovation, innovation related keywords, high ratings from an ideation system, amount of effort or funding related to the general data, and long felt need.

13. The innovation identification system of claim 12, wherein:
the innovation identification module applies a weighting criteria to each of the innovation analyses; and outputs a recommendation of potential innovation of the general data based on the innovation analyses and respective weighting applied.

14. The innovation identification system of claim 12, wherein:
the innovation identification module generates and displays a user interface window asking for innovation feedback; and
the innovation identification module accepts the user feedback and provides the feedback as the direct input of innovation in the innovation analysis.

15. The innovation identification system of claim 14, wherein:
the innovation identification module applies a higher weighting criteria to the direct input of innovation if the user providing the feedback has either the word chief or senior in their job title and a lower weighting criteria to the direct input of innovation if the user providing the feedback does not have either the word chief or senior in their job title.

16. An innovation insights method performed by an innovation insights engine, comprising the steps of:
analyzing innovation data stored in one or more innovation data stores for trigger criteria;
detecting a trigger event based on the one or more trigger criteria;
generating an innovation insight related to the trigger criteria and based on the innovation data; and
providing the innovation insight to a user.

17. The innovation insights method of claim 16, wherein:
the trigger criteria are one or more of a public disclosure; keywords across data stores; a project milestone, a budget update; an internal cycle; an intellectual property committee decision or request; a competitive update; a patent filing; a patent grant; a government requirement or deadline; a lawsuit threat or lawsuit claim filing; or customer requirements.

18. The innovation insights method of claim 16, wherein:
the innovation insight is a pre-populated innovation disclosure form that includes a field indicating the data source information for each innovation datum.

19. The innovation insights method of claim 16, wherein:
the innovation insight is a confidentiality warning based on confidentiality markings found in the analyzed innovation data.

20. The innovation insights method of claim 16, comprising the additional steps of:
receiving user feedback based on the provided innovation insight; and
providing the user feedback to an innovation collection engine.
